(19) United States
(12) Patent Application Publication
(10) Pub. No.: US 2002/0080395 A1
(43) Pub. Date: Jun. 27, 2002

(54) Address printing method and device and address label producing method and device, for tape printing apparatus

(76) Inventor: Hiroyasu Kurashina, Matsumoto-shi (JP)

Correspondence Address: HOGAN & HARTSON L.L.P., 500 S. GRAND AVENUE, SUITE 1900, LOS ANGELES, CA, 90071-2611, US

(21) Appl. No.: 09/925,833

(22) Filed: Aug. 7, 2001

(30) Foreign Application Priority Data
Aug. 31, 2000 (JP) 2000-262740

(51) Int. Cl. G06F 15/00

(52) U.S. Cl. 358/1.15

(57) ABSTRACT

There are provided an address printing method and address printing device for a tape printing apparatus, which are capable of properly printing an address printable on a tape having a specific tape width not only on the tape but also on a tape having another tape width. There are also provided an address label producing method and an address label producing device using the address printing method and device. A tape to be printed is mounted, the tape width thereof is detected, information of n items (n is an integer equal to or larger than 2) which are components of an address of a mail article is registered as address information, and address printing is instructed. When the address printing is instructed, if the tape width is a first tape width, item images representative of information of the n respective items is arranged as respective lines of a single block based on the address information to print the item image. When the address printing is instructed, if the tape width is a second tape width, the item images representative of information of the n respective items are grouped into m blocks (m is an integer defined as 2≦m≦n) based on the address information, the grouped image items are arranged as respective lines of k blocks (k is an integer defined as 1≦k≦m), and the k blocks are printed on a block-by-block basis.

### BACKGROUND OF THE INVENTION

1. Field of the Invention

This invention relates to an address printing method and device and an address label producing method and device, for a tape printing apparatus.

2. Prior Art

Conventionally, a tape printing apparatus has been proposed which is capable of having any of several types of tapes (several types of tape cartridges containing the respective types of tapes) mounted therein, determining (detecting) the tape width of the mounted tape, printing on the tape a character string image having one or more desired characters, such as letters, symbols, numerals and figures, (hereinafter generically referred to as “characters”), in a size corresponding to the number of lines of the character string image and the tape width, and cutting off a printed portion of the tape to a predetermined or desired length, to thereby produce a label.

If the tape printing apparatus of this kind is employed, it is possible to produce a label (address label) printed with the items of a postal code, a postal address, a name, and the like as the address of a receiver, and affix the produced address label to a mail article having a predetermined size to send the mail article. However, the character string images of items (postal code, postal address, name, and the like) which are the components of the address of the mail article necessarily have a lower limit size so as to prevent the inconvenience that the character string images extremely small in size hinder the mail article from being sorted or delivered. Further, the character string images also necessarily have an upper limit size since the character string images extremely large in size are not suitable for being affixed to a mail article having a predetermined size. Therefore, in the conventional tape printing apparatus as described above, an address label is produced by using a tape having a specific tape width suitable for address printing (most suitable in view of the sizes of item images and the size of the whole address area). That is, to produce an address label by carrying out address printing, a tape having a specific suitable tape width is required, and address printing cannot be executed without purchasing the tape.

### SUMMARY OF THE INVENTION

It is a first object of the invention to provide an address printing method and device for a tape printing apparatus, which are capable of appropriately printing an address printable on a tape having a specific tape width, not only on the tape but also on at least one type of a tape having another tape width smaller than the specific tape width.

It is a second object of the invention to provide an address label producing method and device for a tape printing apparatus, which are capable of appropriately printing an address printable on a tape having a specific tape width, not only on the tape but also on at least one type of a tape having another tape width smaller than the specific tape width.

To attain the first object, according to a first aspect of the invention, there is provided an address printing method for a tape printing apparatus, comprising the steps of:

mounting a tape to be printed;

detecting a tape width of the mounted tape;

registering information of n items (n is an integer equal to or larger than 2) which are components of an address of a mail article, as address information;

instructing address printing;

arranging, in response to the instruction of the address printing, item images representative of information of the n respective items based on the address information as respective lines of a single block, and printing the single block, if the detected tape width is a first tape width; and

grouping, in response to the instruction of the address printing, the item images representative of information of the n respective items into m blocks (m is an integer defined as 2≦m≦n) based on the address information, arranging the grouped item images as respective lines of k blocks (k is an integer defined as 1≦k≦m) of the m blocks, and printing the k blocks on a block-by-block basis, if the detected tape width is a second tape width smaller than the first tape width.

To attain the first object, according to a second aspect of the invention, there is provided an address printing device for a tape printing apparatus comprising:

tape mounting means for mounting a tape to be printed;

tape width detection means for detecting a tape width of the mounted tape;

address registration means for registering information of n items (n is an integer equal to or larger than 2) which are components of an address of a mail article, as address information;

address printing instruction means for instructing address printing;

first tape width address printing means for arranging, in response to the instruction of the address printing, item images representative of information of the n respective items based on the address information as respective lines of a single block, and printing the single block, if the detected tape width is a first tape width; and

second tape width address printing means for grouping, in response to the instruction of the address printing, the item images representative of information of the n respective items into m blocks (m is an integer defined as 2≦m≦n) based on the address information, arranging the grouped item images as respective lines of k blocks (k is an integer defined as 1≦k≦m) of the m blocks, and printing the k blocks on a block-by-block basis, if the detected tape width is a second tape width smaller than the first tape width.

According to these address printing method and device, a tape to be printed is mounted, and the tape width of the mounted tape is detected. Further, information of n items (n is an integer equal to or larger than 2) which are components of an address of a mail article is registered beforehand as address information, and address printing is instructed. Here, if the detected tape width is a first tape width, when the address printing is instructed, item images representative of information of the n respective items are arranged as respective lines of a single block, based on the address information and the block is printed. That is, it is possible to arrange the item images representative of information of the n respective items as respective lines of a single block, and print the block on a tape having the first tape width (specific tape width).

Further, if the detected tape width is a second tape width smaller than the first tape width, when the address printing is instructed, the item images representative of information of the n respective items are grouped into the m blocks (m is an integer defined as 2≦m≦n) based on the address information, the grouped item images are arranged as respective lines of the k blocks (k is an integer defined as 1≦k≦m), and the k blocks are printed on a block-by-block basis. That is, the item images can be grouped into m blocks to print each of the grouped blocks, so that even if the detected tape width is not the first tape width (specific tape width), in other words, even if the mounted tape is a tape T having the second tape width (smaller than the first tape width), it is possible to carry out address printing based on the address information. Therefore, an address printable on a tape having the first tape width (specific tape width) can also be printed on a tape having the second tape width (tape width smaller than the first tape width).

Preferably, the address printing method further includes the steps of selecting whether or not a barcode image representative of a customer barcode should be included in the item images representative of information of the n respective items, the customer barcode being formed based on a seven-digit postal code indicating a postal administrative district/town area and an address indication number representative of a subordinate address portion further specific than the postal administrative district/town area, and generating, in response to the instruction of the address printing, the barcode image if it is selected that the barcode image should be included.

Preferably, the address printing device further includes barcode addition selection means for selecting whether or not a barcode image representative of a customer barcode should be included in the item images representative of information of the n respective items, the customer barcode being formed based on a seven-digit postal code indicating a postal administrative district/town area and an address indication number representative of a subordinate address portion further specific than the postal administrative district/town area, and barcode image generation means for generating, in response to the instruction of the address printing, the barcode image if it is selected that the barcode image should be included.

According to these preferred embodiments, it is selected whether or not a barcode image representative of a customer barcode should be included in the item images representative of information of the n respective items, the customer barcode being generated based on a seven-digit postal code indicating a postal administrative district/town area and an address indication number representative of a subordinate address portion further specific than the postal administrative district/town area. Then, if the barcode image is selected as an object to be added to the item images, when the address printing is instructed, the barcode image is generated. Therefore, if the barcode image is selected as an object to be added to the item images, the barcode image can be printed as an item image of the address.

Preferably, barcode numerical value information which is indicative of a numerical value to be represented by a customer barcode can be registered as a portion of the address information, and the step of selecting whether or not a barcode image should be included, includes the steps of determining, in response to the instruction of the address printing, whether or not the barcode numerical value information has been registered, and selecting that the barcode image should be included when it is determined that the barcode numerical value information has been registered, the step of generating the barcode image including generating the barcode image based on the barcode numerical value information.

Preferably, barcode numerical value information which is indicative of a numerical value to be represented by a customer barcode can be registered as a portion of the address information, and the barcode addition selection means includes barcode numerical value information presence/absence determination means for determining, in response to the instruction of the address printing, whether or not the barcode numerical value information has been registered, and barcode addition determination means for selecting that the barcode image should be included when it is determined that the barcode numerical value information has been registered, the barcode image generation means generating the barcode image based on the barcode numerical value information.

According to these preferred embodiments, barcode numerical value information which is indicative of a numerical value to be represented by a customer barcode can be registered as a portion of the address information. When the address printing is instructed, it is determined whether or not the barcode numerical value information has been registered, and when it is determined that the barcode numerical value information has been registered, it is determined that the barcode image should be included in the item images, the barcode image is generated based on the registered barcode numerical value information. Hence, it is possible to carry out address printing for printing an address having the barcode image added thereto simply by registering the barcode numerical value information which is indicative of a numerical value to be represented by the customer barcode, as a portion of the address information.

Preferably, the barcode numerical value information is registered in a state decomposed into information of the seven-digit postal code and information of the address indication number.

According to this preferred embodiment, the barcode numerical value information is registered in a manner decomposed into information of a seven-digit postal code and that of an address indication number. The postal code can be set to the item of a postal code as it is, and the address indication number can be set to a number (e.g. house number) as a subordinate or more specific portion of a postal address, so that if the postal code and the address indication number are used as registered address information when the barcode image is printed, the capacity of memory can be saved by the amount of redundant information.

Preferably, the address printing method further includes the step of storing a block-by-block print items table which defines items corresponding to respective lines of each block to be printed in response to the instruction of the address printing.

Preferably, the address printing device further includes block-by-block printed item storage means for storing a block-by-block print items table which defines items corresponding to respective lines of each block to be printed in response to the instruction of the address printing.

According to these preferred embodiments, block-by-block print items table is stored which defines items corresponding to the respective lines of each block to be printed when the address printing is instructed, so that by referring to the block-by-block print items table, it becomes possible to easily group item images into blocks and arrange the item images as lines of the blocks.

Preferably, the step of storing the block-by-block print items table includes storing an item image print size defining a print size of each item image in a direction of a width of the tape, which item image corresponds to each line of each block to be printed.

Preferably, the block-by-block printed item storage means includes block-by-block item image print size storage means for storing an item image print size defining a print size of each item image in a direction of a width of the tape, which item image corresponds to each line of each block to be printed.

According to these preferred embodiments, the item image print size is stored which defines a print size of each item image in a direction of the width of the tape, the item image corresponding to an item arranged as a line of each block to be printed, so that by appropriately defining the size of each item image in the direction of the width the tape and storing the same, it is possible, by referring to the size, to easily print each item image in an appropriate size and hence the address in an appropriate size.

Preferably, the second tape width includes a plurality of tape widths defined in advance, and the block-by-block print items table defines the items corresponding to respective lines of each block to be printed, for each of the plurality of tape widths.

According to this preferred embodiment, a plurality of types of tape widths which can become the second tape width are defined, and the block-by-block print items table defines an item corresponding to each line of each block to be printed according to each tape width of the defined plurality of types of tape widths. Therefore, it is possible, by referring to the block-by-block print items table, to group the item images into blocks and arrange the item images as lines of the blocks easily and suitably. Therefore, an address printable on a tape having the first tape width (specific tape width) can be appropriately printed on any of tapes having a plurality of the second tape widths (smaller than the first tape width).

Preferably, the address printing method further includes the step of notifying a user, in response to the instruction of the address printing, that the detected tape width is neither the first tape width nor the second tape width if the detected tape width is neither the first tape width nor the second tape width.

Preferably, the address printing device further includes nonconforming tape width notification means for notifying a user, in response to the instruction of the address printing, that the detected tape width is neither the first tape width nor the second tape width if the detected tape width is neither the first tape width nor the second tape width.

According to these preferred embodiments, if the detected tape width is neither the first tape width nor the second tape width, the user is notified of the fact when the address printing is instructed, and hence, the user can understand easily and quickly that appropriate address printing cannot be executed, thereby taking measures to cope with the problem e.g. by replacing tapes.

Preferably, the step of grouping the item images and printing the k blocks on a block-by-block basis when the detected tape width is the second tape width includes the step of designating the k blocks of the m blocks as blocks to be printed.

Preferably, second tape width address printing means includes printed block designation means for designating the k blocks of the m blocks as blocks to be printed.

According to these preferred embodiments, the k blocks (k is an integer defined as 1≦k≦m) of the m blocks (m is an integer defined as 2≦m≦n) are designated as blocks to be printed, whereby it is possible to print any of the blocks ranging from a desired one of the m blocks to all of the m blocks arbitrarily as required. That is, only a required part of the registered destination can be printed.

Preferably, the address printing method further includes the step of notifying a user of a block which is being printed in response to the instruction of the address printing.

Preferably, the address printing device further includes printed block notification means for notifying a user of a block which is being printed in response to the instruction of the address printing.

According to these preferred embodiments, since the user is notified of a block which is being printed in response to the instruction of the address printing, the user can grasp the block being printed, easily and promptly.

Preferably, the address printing method further includes the step of being capable of giving an instruction for canceling the instruction of the address printing, thereby stopping a subsequent printing operation.

Preferably, the address printing device further includes address printing stop means which is capable of giving an instruction for canceling the instruction of the address printing, thereby stopping a subsequent printing operation.

According to these preferred embodiments, an instruction can be provided for canceling the instruction of the address printing after the address printing has been instructed to thereby stop a subsequent printing operation, and hence when the user is aware of his erroneous instruction of address printing, he can stop the address printing (before the start of or in the course of the printing operation), or he can stop the printing operation subsequent thereto after only a required portion of the block ha been printed.

To attain the second object, according to a third aspect of the invention, there is provided an address label producing method for a tape printing apparatus, comprising the steps of:

mounting a tape to be printed;

detecting a tape width of the mounted tape;

registering information of n items (n is an integer equal to or larger than 2) which are components of an address of a mail article, as address information;

instructing address printing;

arranging, in response to the instruction of the address printing, item images representative of information of the n respective items based on the address information as respective lines of a single block, and printing the single block, if the detected tape width is a first tape width;

grouping, in response to the instruction of the address printing, the item images representative of information of the n respective items into m blocks (m is an integer defined as 2≦m≦n) based on the address information, arranging the grouped item images as respective lines of k blocks (k is an integer defined as 1≦k≦m) of the m blocks, and printing the k blocks on a block-by-block basis, if the detected tape width is a second tape width smaller than the first tape width; and

cutting off a printed portion of the mounted tape as an address label.

To attain the second object, according to a fourth aspect of the invention, there is provided an address label producing device for a tape printing apparatus, comprising:

tape mounting means for mounting a tape to be printed;

tape width detection means for detecting a tape width of the mounted tape;

address registration means for registering information of n items (n is an integer equal to or larger than 2) which are components of an address of a mail article, as address information;

address printing instruction means for instructing address printing;

first tape width address printing means for arranging, in response to the instruction of the address printing, item images representative of information of the n respective items based on the address information as respective lines of a single block, and printing the single block, if the detected tape width is a first tape width;

second tape width address printing means for grouping, in response to the instruction of the address printing, the item images representative of information of the n respective items into m blocks (m is an integer defined as 2≦m≦n) based on the address information, arranging the grouped item images as respective lines of k blocks (k is an integer defined as 1k≦m) of the m blocks, and printing the k blocks on a block-by-block basis, if the detected tape width is a second tape width smaller than the first tape width and

tape cutting means for cutting off a printed portion of the mounted tape as an address label.

According to these address label producing method and device, the address is printed, and the printed block portion of the mounted tape is cut off from the tape as an address label, thereby making it possible to produce an address label with ease. More specifically, when the n item images are printed on a tape T having the first tape width (specific tape width), one address label having n item images printed as a single block can be produced, while when the n item images are printed on a tape having the second tape width (tape width smaller than the first tape width), m address labels can be produced by printing the n item images as the m blocks.

Further, only the k blocks (k is an integer defined as 1≦k≦m) of the m blocks (m is an integer defined as 2≦m≦n), that is, only k pieces of the m pieces can be formed as address labels. Therefore, it is possible to print and produce again only an address label erroneously affixed to a mail article, or alternatively to consciously change only a part (e.g. only a name) of an address label, thereby making an address label including only item images required by the user.

The above and other objects, features, and advantages of the invention will become more apparent from the following detailed description taken in conjunction with the accompanying drawings.

### BRIEF DESCRIPTION OF THE DRAWINGS

FIG. 1 is a perspective view of an appearance of a tape printing apparatus to which are applied an address printing method and device and an address label producing method and device according to an embodiment of the present invention;

FIG. 2 is a perspective view showing the FIG. 1 tape printing apparatus with a lid thereof being open;

FIG. 3 is a block diagram schematically showing a control system of the FIG. 1 tape printing apparatus;

FIG. 4 is a flowchart showing a conceptual representation of an overall control process executed by the FIG. 1 tape printing apparatus;

FIG. 5 is a diagram schematically illustrating examples of a display screen and an operating procedure carried out on the display screen, which is useful in explaining typical file handling or editing operations and a printing operation carried out through the file handling or editing operations;

FIG. 6 is a diagram similar to FIG. 5 and continued therefrom, which is useful in explaining an address registration operation;

FIG. 7 is a diagram similar to FIG. 6, which is useful in explaining the address registration operation carried out at the hierarchically lowest one of the levels shown in the FIG. 6;

FIG. 8 is a diagram similar to FIG. 7 and continued therefrom;

FIG. 9 is a diagram similar to FIG. 7 and continued from FIG. 8;

FIG. 10 is a diagram similar to FIG. 7 and continued from FIG. 9;

FIG. 11 is a diagram similar to FIG. 10, which illustrates another example;

FIG. 12 is a diagram similar to FIG. 7 and continued from FIG. 10 or 11;

FIG. 13 is a diagram similar to FIG. 7 and continued from FIG. 12;

FIG. 14 is a diagram illustrating an example of the entry/registration items of address information;

FIG. 15 is a flowchart showing an example of an address (destination) printing process;

FIG. 16 is a flowchart showing an example of an address image forming/printing & address label producing process;

FIG. 17 is a flowchart showing an example of a process for generating a customer barcode;

FIG. 18 is a diagram similar to FIG. 5 and continued therefrom, which is useful in explaining an address printing operation;

FIG. 19 is a diagram similar to FIG. 18, which is useful in explaining the address printing operation carried out at a hierarchically lower level than those shown in FIG. 18;

FIG. 20 is a diagram similar to FIG. 19 and continued therefrom, which is useful in explaining a split printing process;

FIG. 21 is a diagram illustrating an example of items for printing grouped on a block-by-block basis (label-by-label basis) according to tape widths, and sizes (item image print size/character size) of the items in a direction of the width of each tape, when a postal barcode is included in the items of the address;

FIG. 22 is a diagram similar to FIG. 21 in a case in which a postal barcode is not included in the items of the address;

FIGS. 23A to 23D are diagrams illustrating examples of items for address printing and address labels formed based thereon when the tape width is 24 mm;

FIGS. 24A to 24D are diagrams similar to FIGS. 23A to 23D, which illustrate other examples;

FIGS. 25A to 25C are diagrams similar to FIGS. 23A to 23D, which illustrate examples of items for address printing and address labels formed based thereon when the tape width is 18 mm;

FIGS. 26A to 26D are diagrams similar to FIGS. 23A to 23D, which illustrate examples of items for address printing and address labels formed based thereon when the tape width is 12 mm;

FIGS. 27A to 27E are diagrams similar to FIGS. 23A to 23D, which illustrate examples of items for address printing and address labels formed based thereon when the tape width is 9 mm;

FIGS. 28A to 28I are diagrams similar to FIGS. 23A to 23D, which illustrate examples of items for address printing and address labels formed based thereon when the tape width is 6 mm;

FIG. 29A and 29B are diagrams illustrating examples of a change in the layout of the items for printing, according to the tape width; and

FIGS. 30A to 30C are diagrams similar to FIGS. 27A to 27E, which illustrate examples corresponding to FIGS. 29A and 29B.

### DETAILED DESCRIPTION

The invention will now be described in detail with reference to the drawings showing an embodiment thereof. In the embodiment, an address printing method and device and an address label producing method and device according to the invention are applied to a tape printing apparatus.

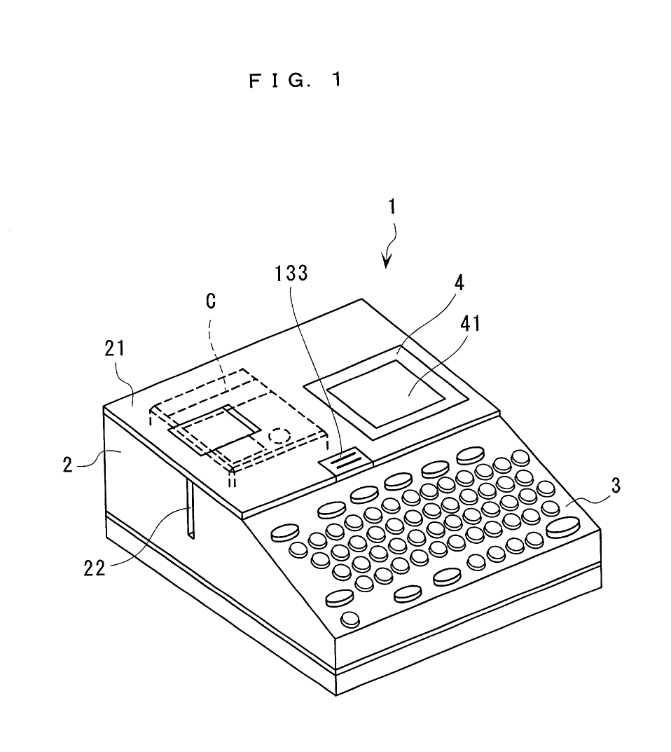

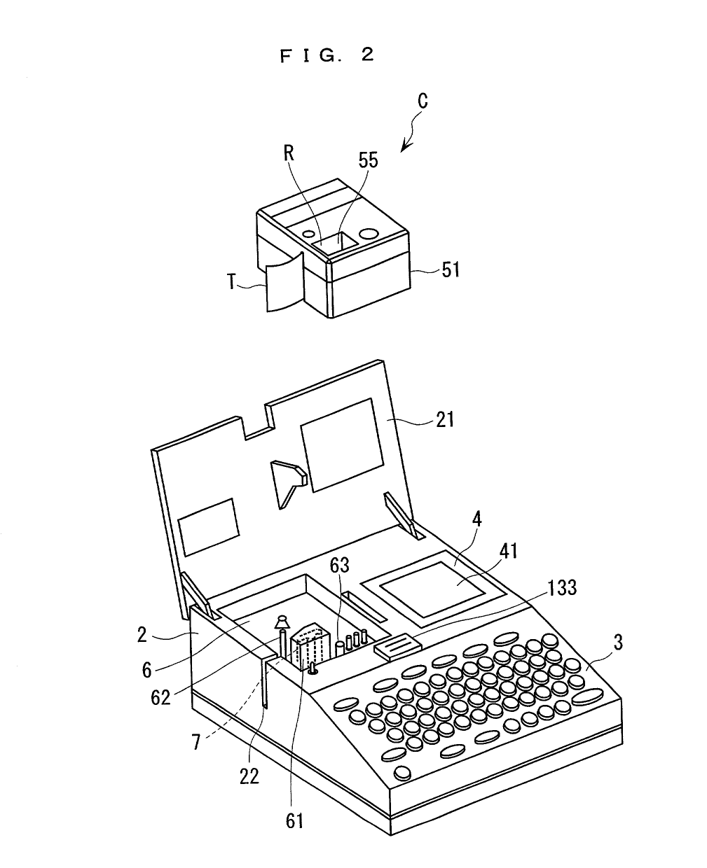

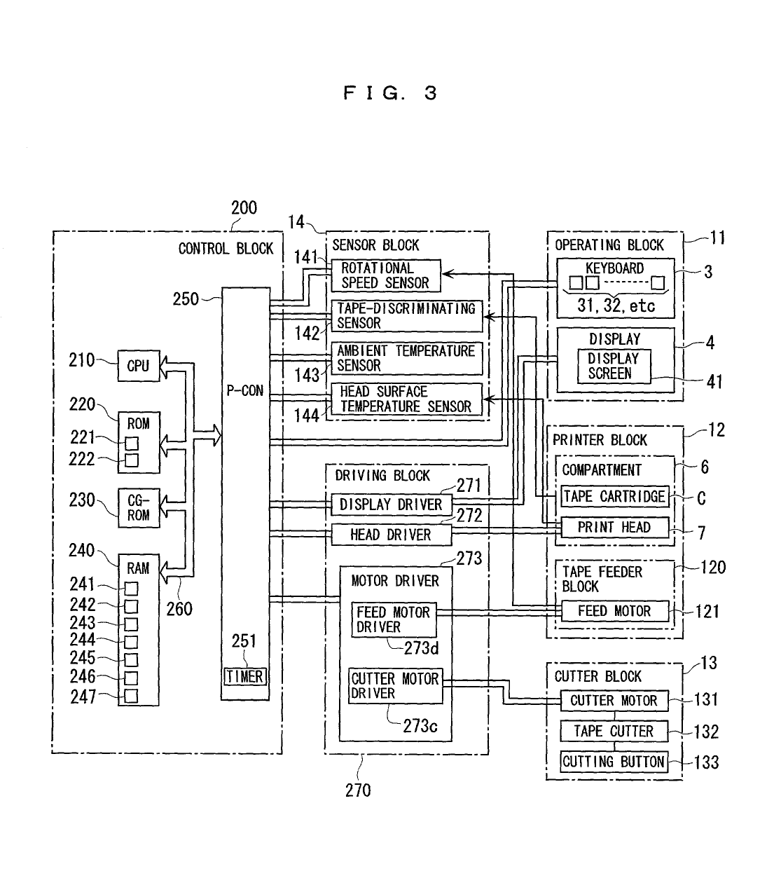

FIG. 1 is a perspective view of an appearance of the whole tape printing apparatus according to the present embodiment, and FIG. 2 is a perspective view of the FIG. 1 tape printing apparatus with its lid being open and a tape cartridge being removed therefrom. FIG. 3 is a block diagram schematically showing a control system of the FIG. 1 tape printing apparatus. As shown in FIGS. 1 and 2, the tape printing apparatus 1 includes a casing 2 having upper and lower divisional portions. The casing 2 has a keyboard 3, which is comprised of various kinds of entry keys, arranged on the top of the front portion thereof, a lid 21 attached to the top of the rear portion thereof, and a display 4 arranged to face a window formed in the right-hand side of the lid 21.

Further, as shown in FIG. 3, the tape printing apparatus 1 is basically comprised of an operating block 11 having the keyboard 3 and the display 4 for interfacing with the user, a printer block 12 having a print head (thermal head) 7 and a tape feeder block 120 for printing on a printing tape (hereinafter simply referred to as “the tape”) T unwound from the tape cartridge C mounted in a compartment 6, a cutter block 13 for cutting off a printed portion of the tape T, a sensor block 14 having various sensors for carrying out various detecting operations, a driving block 270 having drivers for driving circuits of devices of the apparatus 1, and a control block 200 for controlling operations of blocks and devices of the apparatus 1 including the above-mentioned sensors and drivers. To implement the above construction, the casing 2 accommodates a circuit board, not shown, in addition to the printer block 12, the cutter block 13, the sensor block 14 and so forth. On the circuit board are mounted a power supply unit, not shown, and the circuits of the driving block 270 and the control block 200. The circuit board is connected to a connector port for connecting an AC adapter thereto, and batteries, such as nicad batteries, which can be removably mounted within the casing 2 from outside, none of which are shown.

In the tape printing apparatus 1, after mounting the tape cartridge C in the compartment 6, the user enters printing information, such as desired characters (letters, numerals, symbols, simple figures, etc.) via the keyboard 3, while confirming or viewing the results of the entry or edit of the printing information on the display 4. Thereafter, when the user instructs the apparatus 1 via the keyboard 3 to perform a printing operation, the tape feeder block 120 unwinds a tape T from the tape cartridge C, and the print head 7 prints on the tape T. The printed portion of the tape T is delivered from a tape exit 22 as the printing proceeds. When the desired printing operation is completed, the tape feeder block 120 sends the tape T to a position corresponding to an end of a tape length (the length of a label to be formed) including the length of margins, and then stops the feeding of the tape.

As shown in FIGS. 2 and 3, the printer block 12 has the compartment 6 arranged under the lid 21 for mounting the tape cartridge C therein. The tape cartridge C can be mounted in or removed from the compartment 6 when the lid 21 is open. The tape cartridge C has a cartridge casing 51 holding a tape T having a predetermined width (approximately 4.5 to 48 mm) and an ink ribbon R. The tape cartridge C is formed with a through hole 55 for receiving therein a head unit 61 arranged in the compartment 6. Further, the tape cartridge C has a plurality of small holes formed in the bottom thereof for discrimination of a type of the tape T contained therein from the other types of the tape T having different widths, which are contained in other types of tape cartridges C. The compartment 6 has a tape-discriminating sensor 142 including micro-switches or the like for detecting the above holes, whereby the type of the tape T can be detected.

The tape T has an adhesive surface on the reverse side which is covered with a peel-off paper. The tape T and the ink ribbon R are fed or run such that they pass by the through hole 55, in a state lying one upon the other, and the tape T alone is delivered out of the tape cartridge C, but the ink ribbon R is taken up into a roll within the tape cartridge C.

The head unit 61 contains the print head 7 formed of a thermal head. The print head 7 is brought into contact with the reverse side of the ink ribbon R exposed to the through hole 55 of the tape cartridge C when the tape cartridge C is mounted in the compartment 6 with the print head 7 fitted in the through hole 55. Then, by driving the print head 7 while heating the same, desired letters and the like are printed on the surface of the tape T. The compartment 6 is provided with an ambient temperature sensor 143, such as a thermistor, which sends information of an ambient temperature detected thereby to the control block 200. Further, the casing 2 has a left side portion thereof formed with the tape exit 22 for causing the compartment 6 and the outside of the apparatus to communicate with each other. Opposed to the tape exit 22, there is arranged a tape cutter 132 for cutting off a dispensed portion of the tape T. Further, the compartment 6 is provided with drive shafts 62, 63 for engagement with driven portions of the tape cartridge 4 mounted in the compartment 6. A feed motor 121 as a drive source drives these drive shafts 62, 63 for rotation to feed or advance the tape T and the ink ribbon R in the tape cartridge C, and at the same time the print head 7 is driven in synchronism with the feeding of the tape and ribbon to carry out printing. Further, after completion of the printing operation, the tape T continues to be fed to bring a predetermined cutting position (corresponding to the tape length) on the tape T to the position of the tape cutter 132.

It should be noted that a head surface temperature sensor 144 formed e.g. by a thermistor is arranged on a surface of the print head 7 in a manner intimately contacting the surface, which sends information of the surface temperature of the print head 7 detected thereby to the control block 200. The feed motor 121 has an end on which is rigidly fitted a disc, not shown, formed with detection openings, and a rotational speed sensor 141 including a photo sensor or the like is provided to face the path of the detection openings, for sending information of the rotational speed of the feed motor 121 detected thereby to the control block 200.

The cutter block 13 includes a tape cutter 132, a cutting button 133 for being manually operated to cause the tape cutter 132 to cut the tape T when a desired length printing is carried out, for instance, and a cutter motor 131 for automatically driving the tape cutter 132 to cut the tape T when a fixed length printing is carried out, for instance. To selectively carry out one of the two kinds of cutting, the tape printing apparatus 1 is capable of being switched between a manual cutting mode and an automatic cutting mode according to a mode-setting operation. More specifically, in the manual cutting mode, when the printing operation is completed, the user pushes the cutting button 133 arranged on the casing 2, whereby the tape cutter 132 is actuated to cut the tape T to a desired length. On the other hand, in the automatic cutting mode, after completion of the printing operation, the tape T is sent for incremental feed by the length of a rear margin, and then stopped, whereupon the cutter motor 131 is driven to cut off the tape T.

The sensor block 14 includes the rotational speed sensor 141, the tape-discriminating sensor 142, the ambient temperature sensor 143 and the head surface temperature sensor 144. It should be noted that the above sensors can be omitted to suit the actual requirements of the tape printing apparatus.

The driving block 270 includes a display driver 271, a head driver 272, and a motor driver 273. The display driver 271 drives the display 4 of the operating block 11 in response to control signals delivered from the control block 200, i.e. in accordance with commands carried by the signals. Similarly, the head driver 272 drives the print head 7 of the printer block 12 in accordance with commands from the control block 200. Further, the motor driver 273 includes a feed motor driver 273d for driving the feed motor 121 of the printer block 12, and a cutter motor driver 273c for driving the cutter motor 131 of the cutter block 13, and similarly to the display driver 271 and the head driver 272, drives each motor in accordance with commands from the control block 200.

The operating block 11 includes the keyboard 3 and the display 4. The display 4 has a display screen 41 which is capable of displaying display image data of 96×64 dots on a rectangular display area of approximately 6 cm in the horizontal direction (X direction)×4 cm in the vertical direction (Y direction). The display 4 is used by the user when he enters data, instructions or commands via the keyboard 3 to form or edit print image data, such as character string image data (i.e. text print data, referred to hereinafter), and check the result of the entry.

On the keyboard 3, there are arranged a character key group 31 including an alphabet key group, a symbol key group, a number key group 313, not shown in FIG. 3, and a nonstandard character key group for calling nonstandard characters for selection, as well as a function key group 32 for designating various operation modes. In a type of the apparatus which is capable of inputting the Japanese language, the character key group 31 also includes a kana key group for inputting Japanese hiragana letters and Japanese katakana letters.

The function key group 32 includes a power key, not shown, a print key, not shown, for instructing the apparatus 1 to perform a printing operation, a selection key 323, not shown in FIG. 3, for finally determining the entry of character data and feeding lines during text entry as well as determining selection of one of modes or options on a selection screen, a decoration-setting key, not shown, for setting a decoration, such as a so-called character decoration e.g. by hatching, underlining, boxing, etc. or a background decoration (including a background pattern, an illustration and the like), a color-setting key, not shown, for setting colors (including gray levels, color saturation, luster, transparency, and so forth) of characters, a background and a decoration, and four cursor keys 330 (up arrow key 330U, down arrow key 330D, left arrow key 330L, and right arrow key 330R), none of which are shown in FIG. 3, for moving the cursor or the display range of print image data on the display screen 41 in respective upward, downward, leftward, and rightward directions.

The function key group 32 also includes a cancel key 326, not shown in FIG. 3, for canceling instructions, a shift key 327, not shown in FIG. 3, for use in changing roles of respective keys as well as modifying registered image data, a file key 332, not shown in FIG. 3, for selecting a file, a conversion key 342, not shown in FIG. 3, for carrying out various conversions, an image key, not shown, for alternately switching between a text entry screen or a selection screen and a display screen (image screen) for displaying print image data, a proportion-changing (zoom) key, not shown, for changing a proportion between the size of a print image and the size of a display image displayed on the image screen, a form key, not shown, for setting formats, including typefaces.

Of course, similarly to keyboards of the general type, the above-mentioned key entries may be made by the respective keys exclusively provided therefor or by a smaller number of keys operated in combination with the shift key and/or the like. Here, for purposes of ease of understanding, the following description will be made assuming that there are provided as many keys as described above. As shown in FIG. 3, by using the keyboard 3, various commands described above and data are input to the control block 200.

The control block 200 includes a CPU 210, a ROM 220, a character generator ROM (CG-ROM) 230, a RAM 240, a peripheral control circuit (P-CON) 250, all of which are connected to each other by an internal bus 260. The ROM 220 has a control program area 221 for storing control programs executed by the CPU 210 as well as a control data area 222 for storing control data including a color conversion table, a character modification table and the like. The CG-ROM 230 stores font data, i.e. data defining characters, symbols, figures and the like, provided for the tape printing apparatus 1. When code data for identifying a character or the like is input thereto, it outputs the corresponding font data.

The RAM 240 is supplied with power by a backup circuit, not shown, such that stored data can be preserved even after the power is turned off by operating the power key. The RAM 240 includes areas of a register group 241, a text data area 242 for storing text data of letters or the like input by the user via the keyboard 3, a display image data area 243 for storing image data displayed on the display screen 41, a print image data area 244 for storing print image data, a registered image data area 245 for storing registered image data, as well as a print record data area 246 and conversion buffer areas 247 including a color conversion buffer. The RAM 240 is used as a work area for carrying out the control process.

The P-CON 250 incorporates a logic circuit for complementing the functions of the CPU 210 as well as dealing with interface signals for interfacing between the CPU 210 and peripheral circuits. The logic circuit is implemented by gate arrays, a custom LSI and the like. For instance, a timer 251 is also incorporated in the P-CON 250 for the function of measuring elapsed time. To perform its functions, the P-CON 250 is connected to the sensors of the sensor block 14 and the keyboard 3, for receiving the above-mentioned signals generated by the sensor block 14 as well as commands and data input via the keyboard 3, and inputting these to the internal bus 260 directly or after processing them. Further, the P-CON 250 cooperates with the CPU 210 to output data and control signals input to the internal bus 260 by the CPU 210 or the like, to the driving block 270 directly or after processing them.

The CPU 210 of the control block 200 receives the signals from the sensor block 14, and the commands and data input via the keyboard 3 via the P-CON 250, according to the control program read from the ROM 220, processes font data from the CG-ROM 230 and various data stored in the RAM 240, and delivers control signals to the driving block 270 via the P-CON 250 to thereby carry out position control during printing operations, display control of the display screen 41, and printing control of the print head 7 to carry out printing on the tape T under predetermined printing conditions. In short, the CPU 210 controls the overall operation of the tape printing apparatus 1.

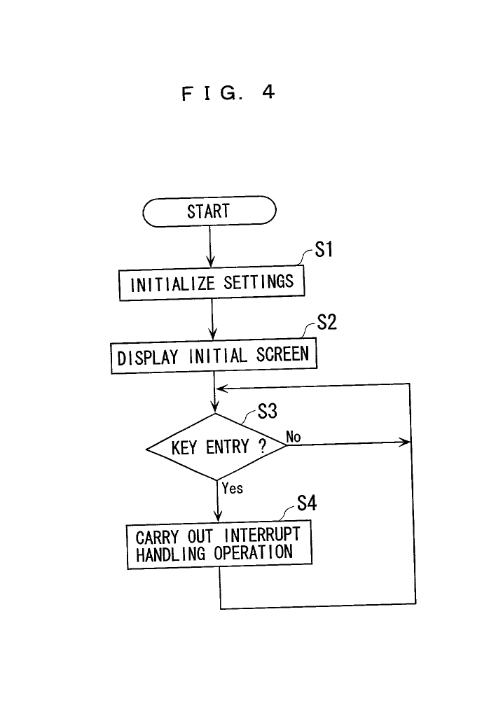

Next, the overall control process carried out by the tape printing apparatus 1 will be described with reference to FIG. 4. As shown in the figure, when the program for carrying out the control process is started e.g. when the power of the tape printing apparatus 1 is turned on, first, initialization of the system including restoration of saved control flags is carried out to restore the tape printing apparatus 1 to the state it was in before the power was turned off the last time (S1). Then, the image that was displayed on the display screen 41 before the power was turned off the last time is shown as an initial screen (S2).

The following steps in FIG. 4, that is, a step S3 for determining whether or not a key entry has been made and a step S4 for carrying out an interrupt handling operation are conceptual representations of actual operations. Actually, when the initial screen has been displayed (S2), the tape printing apparatus 1 enables an interrupt by key entry (keyboard interrupt), and maintains the key entry wait state (No to S3) until a keyboard interrupt is generated. When the keyboard interrupt is generated (Yes to S3), a corresponding interrupt handling routine is executed (S4), and after the interrupt handling routine is terminated, the key entry wait state is again enabled and maintained (No to S3).

As described above, in the tape printing apparatus 1, main processing operations by the apparatus are carried out by interrupt handling routines, and hence if print image data for printing is provided or has been prepared, the user can print the image data at a desired time, by depressing the print key at the desired time and thereby generating a print interrupt to start a printing process, whereby the user can print a print image based on the print image data at the desired time. In short, the user can select any of possible operating procedures up to the printing operation as he desires.

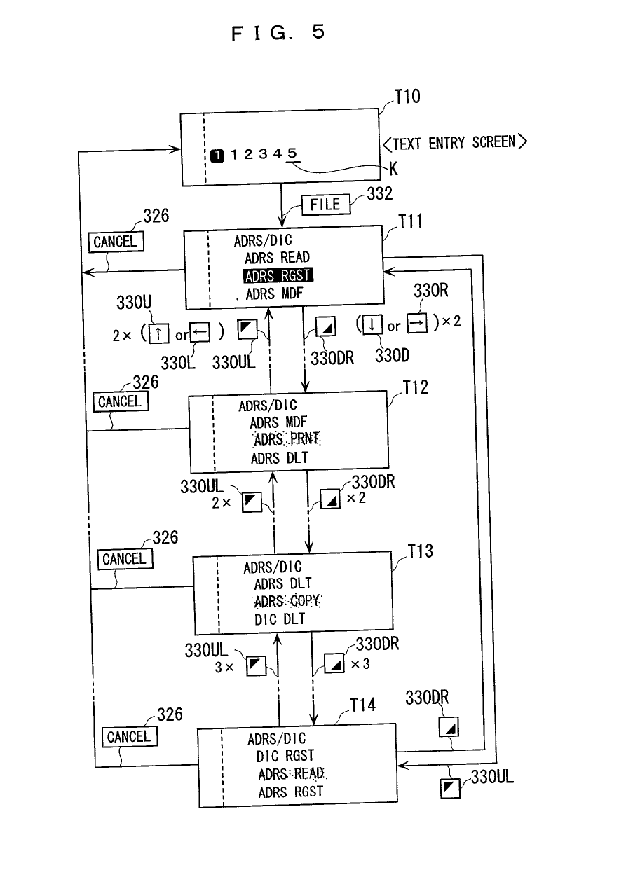

For instance, as shown in FIG. 5, if the print key is depressed by the user when the text entry screen displays a character string “12345” as a first line of the entry by the user [screen T10: hereinafter, contents displayed on the display screen 41 of the display 4 are referred to as the “screen T??” (? represents a digit) and the reference numerals for the screens are shown only by T??. Further, a cursor position is indicated in figures by a symbol K], the character string image of the character string “12345” can be printed as a print image. Here, detailed description of this printing operation will be omitted since such a character string image is printed similarly to the conventional printing apparatus.

The tape printing apparatus 1 is configured such that it is capable of printing not only a character string image as described above but also an address to be provided on a mail article by carrying out address printing. More specifically, in the tape printing apparatus 1, it is possible to selectively carry out first address printing and second address printing. In the first address printing, a customer barcode generated based on a seven-digit postal code indicating a postal administrative district/town area and an address indication number representative of a subordinate address portion further specific than the postal administrative district/town area is printed as part of the address including the postal code. In the second address printing, the customer barcode is not included in the address. Further, in the tape printing apparatus 1, since a printing object is the aforementioned tape T which can be affixed to a mail article as described hereinabove, it is possible to print an address by the address printing to affix the address to a mail article. Although in a general address printing device, as the printing object of the above mentioned kind, there may be considered e.g. a piece of cloth or paper, a plastic thin film, a tape or the like, which may be affixed to a mail article by being cut to a size for affixation, in the tape printing apparatus 1, the tape T is a printing object, so that it is possible to produce a label (so-called address label) to be attached to a mail article by cutting a portion printed with an address off the tape T.

Generally, when a mail article or an object to be affixed to the mail article is a printing object, the mail article has a predetermined size set thereto, and hence the size of a printing area thereof is also limited. Further, since the size of the printing area is limited, a first address printing size defined as the size of a printing area of the above first address printing and a second address printing size defined as the size of a printing area of the above second address printing can have the same size in at least one of a vertical size and a horizontal size thereof Further, if the first address printing size and the second address printing size are set to have an identical length in at least one of the vertical and horizontal directions, by setting the identical length to a length in the direction of the width of a printing object which is in the form of a tape and longer in the direction of the length thereof orthogonal to the direction of the width thereof, so as to affix a printed portion to a mail article, whichever of the first address printing or second address printing may be carried out, it is possible to obtain a to-be-affixed object (e.g. a seal, a label and so forth) printed with an address, simply by cutting the tape at a position in the direction of the length of the object.

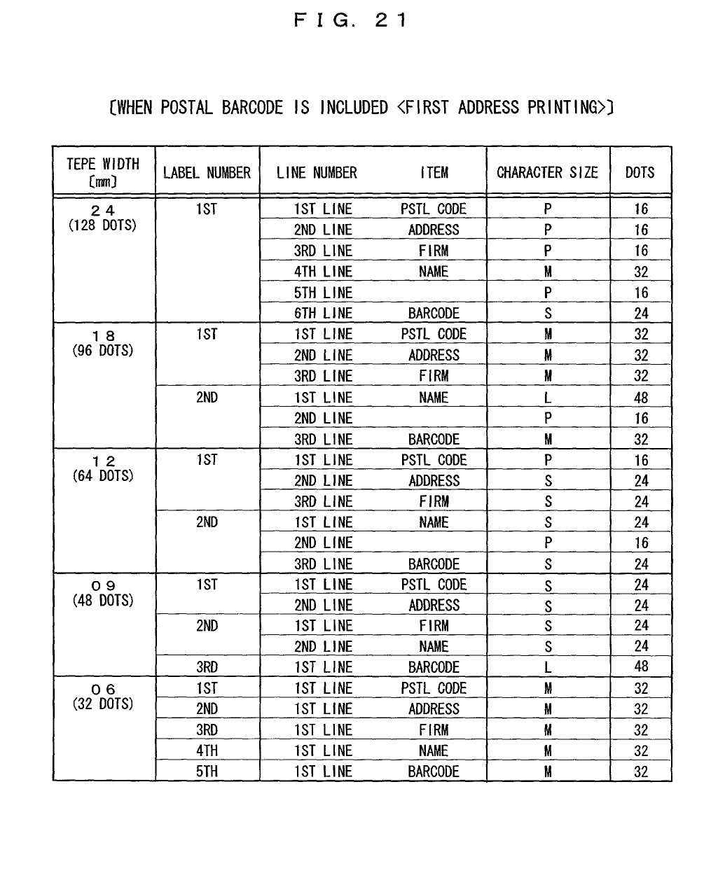

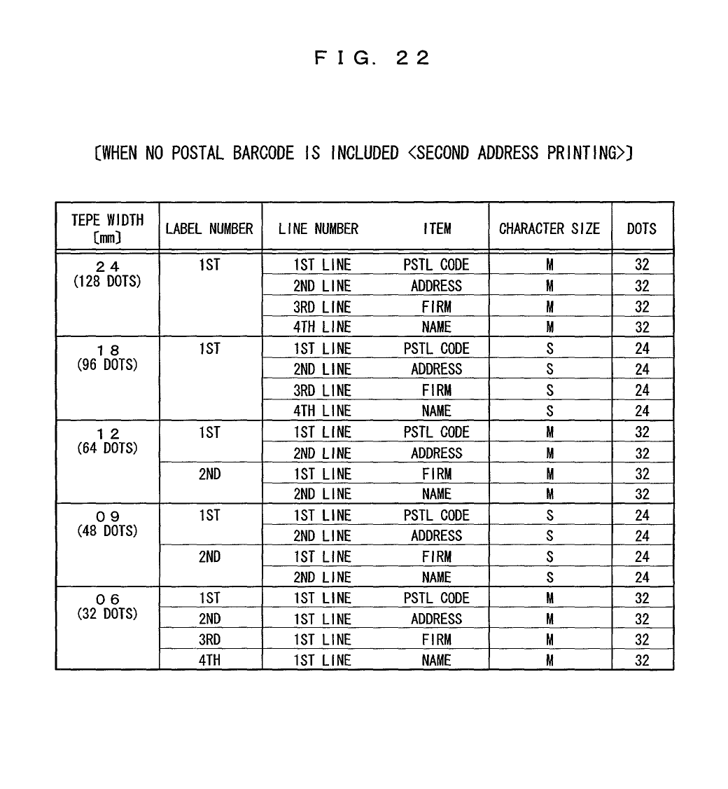

Therefore, in the tape printing apparatus 1 as well, the first address printing size and the second address printing size as described above are set or determined. Particularly, the first address printing size is determined based on the defined printing size of a customer barcode. Further, in the address printing, tapes T having tape widths of 24 mm, 18 mm, 12 mm, 9 mm, and 6 mm can be utilized, and methods thereof (print formats: split printing, character sizes, etc.) depend on the tape widths (see FIGS. 21 and 22). Differences between the address printing methods dependent on the tape width will be described later. In the following description (FIGS. 5 to 14), let it be assumed for the time being that a tape T having a specific tape width (first tape width) of 24 mm is used in printing operation. When the tape T which has the tape width of 24 mm set to the above identical size (in at least one of the vertical size and the horizontal size of the first address printing size and the second address printing size) is employed, whichever of the first address printing and second address printing may be carried out, it is possible to obtain address labels or the like with ease simply by cutting off the tape T at a position in the direction of the length thereof.

Hereinafter, the above address printing will be described in detail with reference to the drawings(in the following, the term “address” is used in place of the term “destination” as required, since the term “address” is more familiar to the user) . First, for instance, when the file key 332 is depressed by the user in the state (T10) of the text entry screen being displayed, described above with reference to FIG. 5, as shown in the figure, a selection screen at a first hierarchical level positioned under the option of “ADRS/DIC” (abbreviation of “address/dictionary” to fit in the display screen; hereinafter abbreviations are explained in the respective following parentheses) is displayed (T11). This selection screen is for handling or editing files and carrying out printing operation by using the handled or edited files. It should be noted that in the tape printing apparatus 1, the user can cancel instructions provided via the keyboard 3 by operating the cancel key 326. That is, the selection screen can be returned to the original text entry screen (T10) by depressing the cancel key 326 in the state of the screen at the first hierarchical level (T11 to T14) being displayed (the cancel key 326 similarly acts in all cases unless otherwise specified, and hence description of this operation in each state of the screen will be omitted hereinafter).

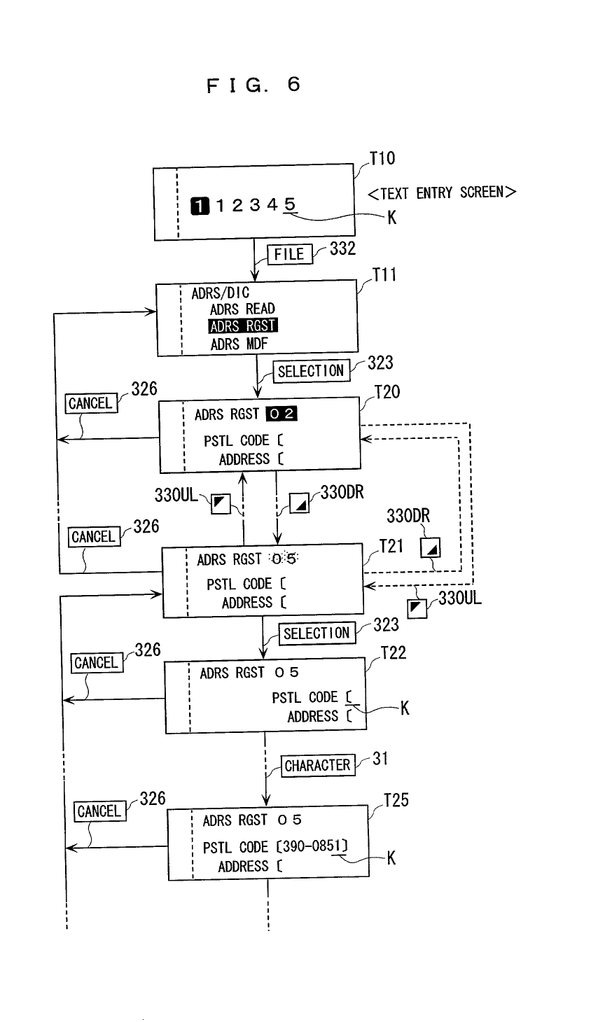

On the selection screen (T11), menu options, such as “DIC DLT” (dictionary delete), “DIC RGST” (dictionary registration), “ADRS READ” (address reading), “ADRS RGST” (address registration), “ADRS MDF” (address modification), “ADRS PRNT” (address printing), “ADRS DLT” (address delete), “ADRS COPY” (address copy), and the like are displayed as menu options of “ADRS/DIC”. The user can display any one of the menu options in reverse video or in a flashing state (in the illustrated examples, expressed by shading of character images with dots) by operating the cursor key 330, and select and designate the menu option displayed in reverse video or in the flashing state by depressing the selection key 323. As shown in FIG. 5, immediately after the file key 332 is depressed, an option selected (accessed) the last time (or an option selected by default according to the result of initialization of the system, if there is no option selected the last time), such as the option “ADRS RGST” in the illustrated example, is displayed in reverse video (T11) When the selection key 323 is depressed by the user in this state (T11), the option “ADRS RGST” is selected to switch to a selection screen at a second hierarchical level positioned under the option of “ADRS RGST” (SEE FIG. 6). Further, when the down arrow key 330D or the right arrow key 330R is depressed in the above state (T11), the next option “ADRS MDF” is displayed in the flashing state (not shown) since it is not the option selected the last time. When the selection key 323 is depressed in this state, the option “ADRS MDF” is selected to switch to a selection screen at the second hierarchical level positioned under the option of “ADRS MDF”.

As described above, an option displayed in reverse video or in the flashing state on a selection screen of the tape printing apparatus 1 is one to be selected by subsequent user's operation of the selection key 323, and hence the option in one of these states is referred to as an option “highlighted for selection”. More specifically, when the down arrow key 330D or the right arrow key 330R is depressed with the option “ADRS RGST” being highlighted for selection (T11), the option “ADRS MDF” is highlighted for selection. Similarly, when the up arrow key 330U or the left arrow key 330L is depressed with the option “ADRS MDF” being highlighted for selection, the option “ADRS RGST” is highlighted for selection (T11) . In the following, for efficiency of description, the down arrow key 330D and the right arrow key 330R are collectively referred to as the “cursor key 330DR” which is represented in FIG. 5 as a box containing a black triangle pointing in a downward and rightward direction. Similarly, the up arrow key 330U and the left arrow key 330L are collectively referred to as the “cursor key 330UL” which is represented in the figure as a box containing a black triangle pointing in a upward and leftward direction.

Similarly, when the cursor key 330DR is operated in a state of the option “ADRS MDF” being highlighted for selection, the next option “ADRS PRNT” is highlighted for selection (T12). Similarly, following the above, whenever the cursor key 330DR is operated, all the options are sequentially highlighted for selection cyclically in the order of the options “ADRS PRNT”, “ADRS DLT”, “ADRS COPY”, “DIC DLT”, “DIC RGST”, “ADRS READ”, “ADRS RGST”, “ADRS MDF”, . . . , and so on (T11 to T14). By depressing (operating) the selection key 323 in a state of any of the options being highlighted for selection, the user can determine the selection of the desired option. Further, from the state of the option “ADRS RGST” being highlighted for selection (T11), whenever the cursor key 330UL is operated, all the options are sequentially highlighted for selection cyclically, that is, in the order of the options “ADRS READ”, “DIC RGST”, “DIC DLT”, “ADRS COPY”, “ADRS DLT”, “ADRS PRNT”, “ADRS MDF”, “ADRS RGST”, . . . , and so on. In short, the user can highlight a desired option for selection by operating the cursor key 330(cursor key 330DR or cursor key 330UL) and finally select or determine the selection of the highlighted option by the selection key 323.

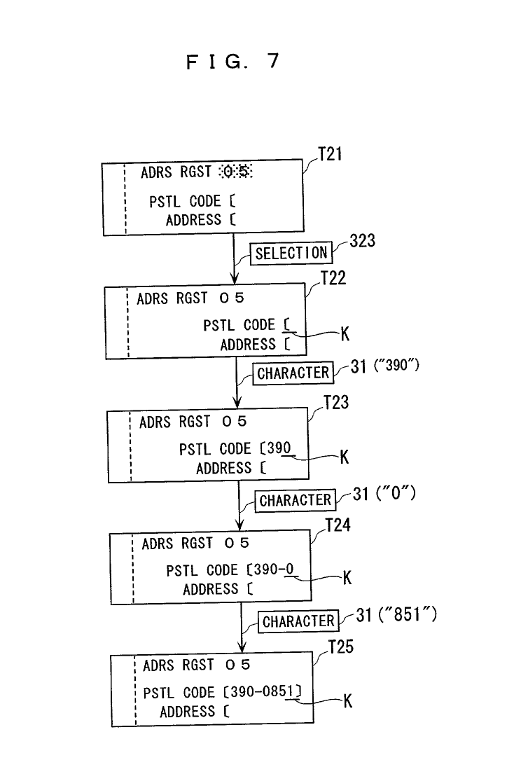

Next, e.g. as shown in FIG. 6, when the selection key 323 is depressed in a state of the option “ADRS RGST” being highlighted for selection (T11: commonly shown in FIG. 5), the option “ADRS RGST” is selected to switch to a selection screen for selecting a registration number of the address registration, at the second hierarchical level positioned under the option of “ADRS RGST” (T20). On this selection screen for selecting a registration number, an unregistered registration number is displayed in reverse video or in the flashing state. In this processing, first, the smallest one of unused registration numbers available for registration is displayed in reverse video (T20) Similarly to the case of the selection screen positioned at the first hierarchical level, the user can highlight a desired option (registration number) for selection (cyclically) by operating the cursor key 330 (T20 and T21: indicated by imaginary lines (dotted lines) with arrowheads in the figure since a selected option (registration number) is not shown, and the same applies hereinafter), and finally determine the selection of the highlighted option by operating the selection key 323. In this case, for instance, when the selection key 323 is depressed in a state of a registration number “05” being highlighted for selection (T21: commonly shown in FIGS. 6 and 7), the screen is switched to an entry screen of the registration number “05”, at a third hierarchical level positioned under the option of “ADRS RGST” (T22: commonly shown in FIGS. 6 and 7).

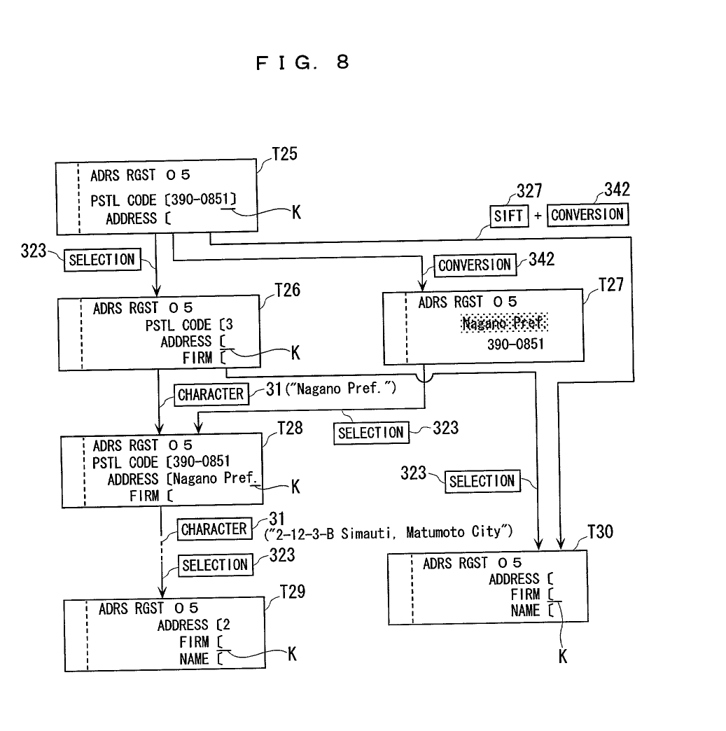

Next, for instance, as shown in FIG. 7, in a first state of the entry screen of the registration number “05”, first, the cursor K prompts the user to enter “PSTL CODE” (postal code) (T22). When the user operates the character key group 31 in this state (T22) to enter a character string (postal code) e.g. of “390-0851” (T22 to T25: T25 is commonly shown in FIGS. 6 and 8), and the selection key 323 is depressed, then, the cursor K prompts the user to enter “ADRRESS” (T26).

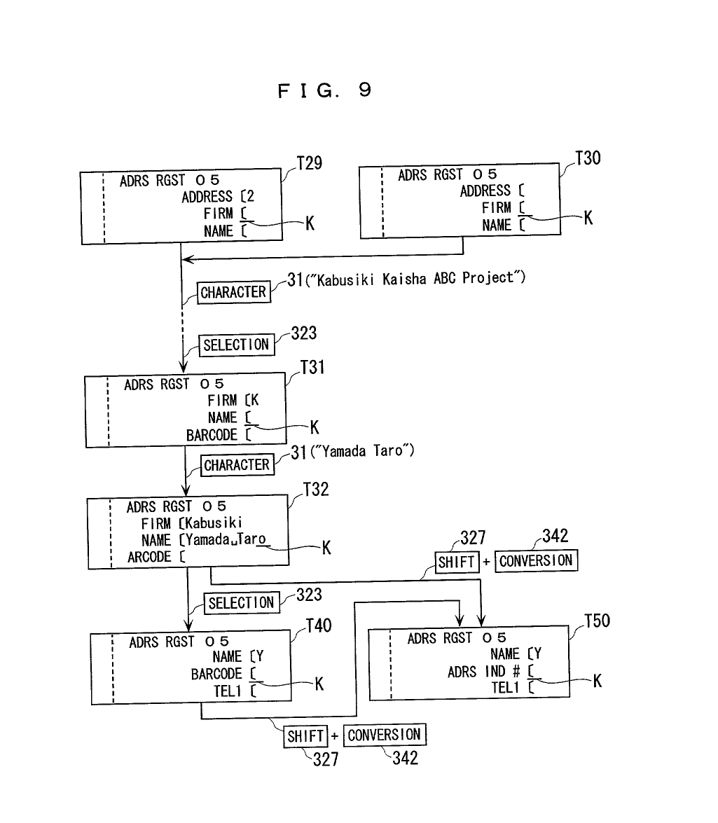

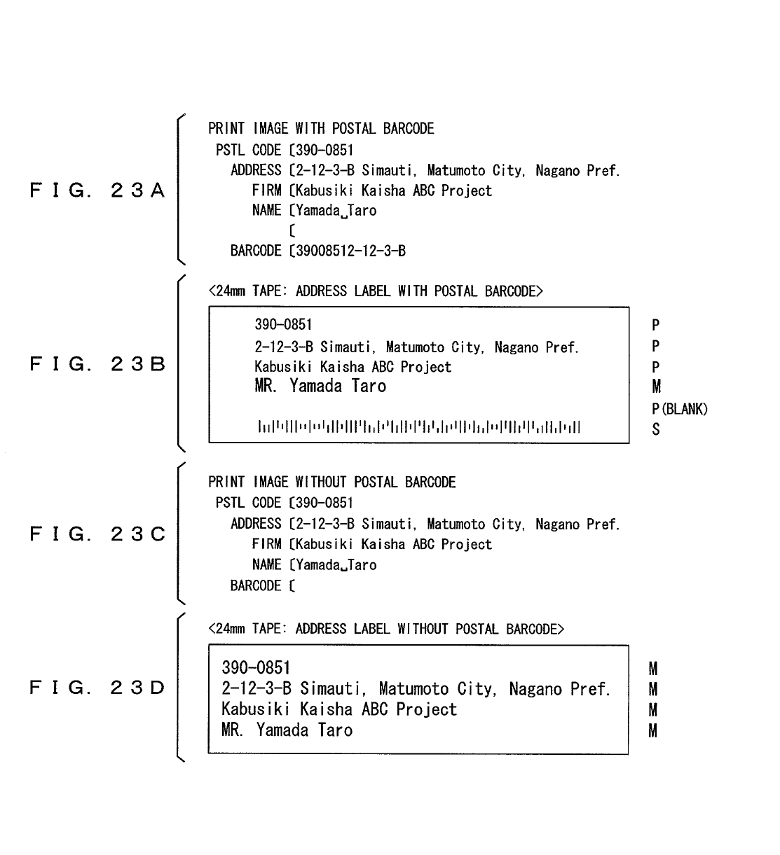

After the user operates the character key group 31 from the above state (T26) to enter a character string (postal address) “Nagano Pref.” (T28), for instance, and then “2-12-3-B Shimauti, Matumoto City” (see FIGS. 23A and 23D), if the selection key 323 is depressed, the cursor K prompts the user to enter “FIRM” (firm name) (T29: commonly shown in FIGS. 8 and 9). It should be noted that in the state of the postal code “390-0851” having being entered (entry of a postal code having been completed) (T25), if the conversion key 342 is depressed, a candidate (“Nagano Pref.” in this example) for the name of a prefecture corresponding to the postal code is displayed in the flashing state (T27), and if the selection key 323 is depressed in this state, the entry of the name of the prefectures is finally determined, whereby the user can enter the name of a prefecture by operating the conversion key 342 and the selection key 323 instead of operating the character key group 31. In this case, it is also possible to highlight another candidate (name of a prefecture) for selection by operating the cursor key 330 from the state of the first candidate being displayed in the flashing state (T27), and finally determine the selection of the highlighted option by the selection key 323. It should be noted that in the illustrated example, out of the components of an address, the name of a prefecture is entered first (according to the order of components of a Japanese postal address), and this first entered component is automatically moved to the end of the address upon completion of entry of the item of the address. Of course, the tape printing apparatus 1 may be configured such that also when an address used in the United States and the like is entered, by prompting the user to first enter the name of a state, and moving the entered name of the state to the end of the address exclusive of a ZIP code upon completion of the entry of the address, it is possible to obtain the advantageous effects of the above-described method of making use of an entered postal code (i.e. ZIP) in entry of a postal address.

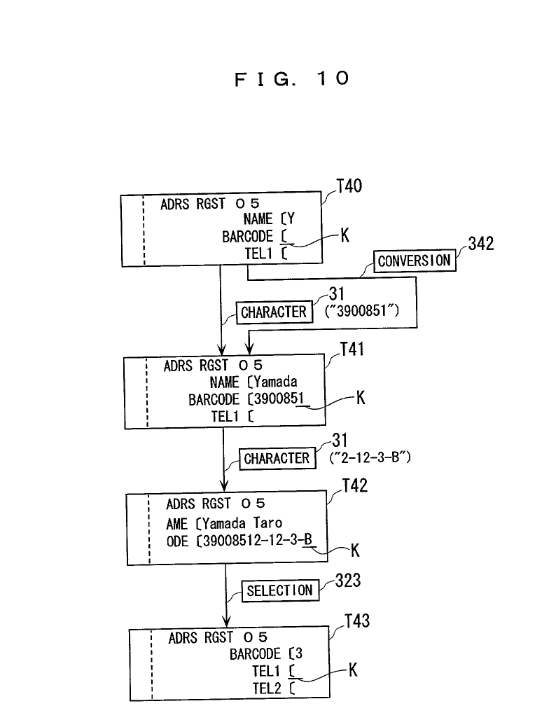

Next, as shown in FIG. 9, from the state of the entry of “FIRM” (firm name) being prompted (T29), after operating the character key group 31 to enter a character string (corporate name) “Kabushiki Kaisha ABC Project” (see FIG. 23), for instance, if the user depresses the selection key 323, the cursor K prompts the user to enter “NAME” (T31) . After operating the character key group 31 from the above state (T31) to enter a character string (name) “Yamada Taro” (see FIG. 23), for instance, if the user depresses the selection key 323, the cursor K prompts the user to enter “BARCODE” (barcode numerical value information) (T40: commonly shown in FIGS. 9 and 10).

Next, for instance, as shown in FIG. 10, after operating the character key group 31 from the above state (T40) to enter the character string “3900851” (postal code: where the hyphen “−” thereof is omitted to convert the postal code number into a first portion of the barcode numerical value information) and continuously the character string (address indication number) “2-12-3-B” (see FIGS. 23A to 23D) are entered, if the user depresses the selection key 323, the cursor K prompts the user to enter “TELL1” (phone number 1) (T43: commonly shown in FIGS. 10 to 12).

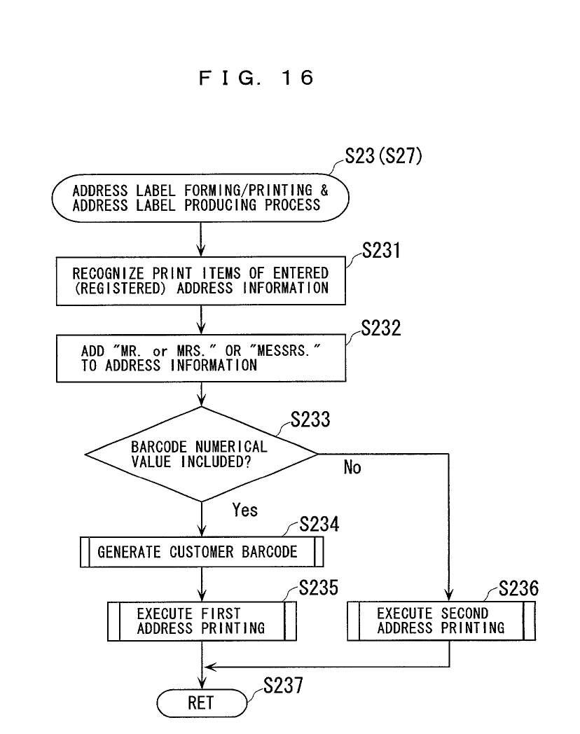

As described hereinabove, in the tape printing apparatus 1, a seven-digit postal code indicating a postal administrative district/town area and an address indication number representative of a subordinate address portion further specific than the postal administrative district/town area are directly input with numerical values thereof to provide barcode numerical value information for generating a customer barcode. Further, as described hereinafter, the customer barcode is generated based on the barcode numerical value information, and in response to an address printing operation for printing an address including a postal code, on a tape (printing object) T, the first address printing is carried out as address printing for printing an address including the customer barcode, on the tape T, on condition that the barcode numerical value information has been entered before the instruction is provided (see S235 in FIG. 16 and FIGS. 23A and 23B).

In the new mail processing system put into effect from Feb. 2, 1998, in Japan, by the Japanese Government, it is possible, in principle, to deliver a mail article if it has a seven-digit postal code and an address indication number written (printed) thereon. Further, it is also possible, in principle, to generate a customer barcode if only information of a seven-digit postal code and an address indication number is provided. Therefore, it is contemplated that in the future, similarly to the notation of an E-mail address which is now becoming popular, an address indication number comes to be written in combination with a seven-digit postal code as collateral information written in a sender address column of a mail article, or as collateral information written in an address area on a business card of a business person or an employed or self-employed individual. Further, it is likely that a postal code book or the like will be published which includes address indication numbers and is similar to the current phone book.

Now, if the sender knows the address indication number of an addressee, or if he can easily extract or imagine an address indication number of an addressee from collateral information of the addressee's postal address, in other words, if the new mail processing system is promoted to make the address indication number further generally known and cause printing of customer barcode to be put into more general practice, it is expected that an address indication number can be directly entered with its numerals with ease. Further, in this case, since the seven-digit postal code indicating a postal administrative district/town area is already known, it also becomes easy to form barcode numerical value information by directly inputting an address indication number representative of a subordinate address portion further specific than the postal administrative district/town area, by using a numerical value thereof. Further, if the address indication number or the barcode numerical value information formed by a combination of the address indication number and the postal code is directly input, a customer barcode can be generated based on the input code or information, which makes it possible to dispense with extra processing time for extracting an address indication number based on a subordinate address portion further specific than the postal administrative district/town area, or extra capacity of memory (for software or the like used in the extraction).

On the other hand, in the example described above with reference to FIG. 10, the seven-digit postal code indicating a postal administrative district/town area and the address indication number representative of a subordinate address portion further specific than the postal administrative district/town area are directly input by inputting numerical values thereof as portions of barcode numerical value information for generating a customer barcode (T40 to T42) . That is, if the new mail processing system is promoted to make the address indication number further known and cause printing of customer barcode to be put into more general practice, the tape printing apparatus 1 can generate a customer barcode more easily from directly entered barcode numerical value information and carry out the address printing to print an address including the customer barcode, while reducing extra processing time or extra capacity of memory.

It should be noted that if the conversion key 342 is depressed from the state of the entry of “BARCODE” (barcode numerical value information) being prompted (T40), since a portion of barcode numerical value information based on a postal code is in the form of a barcode from which the hyphen “-” is omitted, the character string “390-0851” already input as the postal code, is input as the portion of barcode numerical value information after omitting the hyphen “-”. In other words, the user can input the postal code-based portion of the barcode numerical value information not by operating the character key group 31 but by operating the conversion key 342. Further, the fact that the postal code-based portion of the barcode numerical value information can be input by operating the conversion key 342 means that if only the address indication number is newly entered, the whole barcode numerical value information can be generated based on the address indication number and the character string “390-0851” already input as the postal code without inputting the postal code again. Therefore, the tape printing apparatus 1 employs not only the method of inputting the postal code-based portion of barcode numerical value information by operating the conversion key 342 but also the method of directly entering an address indication number while omitting the process of entry of a postal code-based portion of barcode numerical value information which can be entered by the conversion from the barcode.

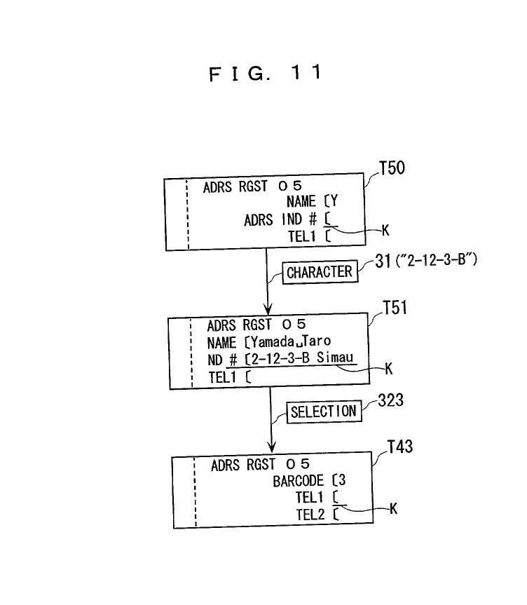

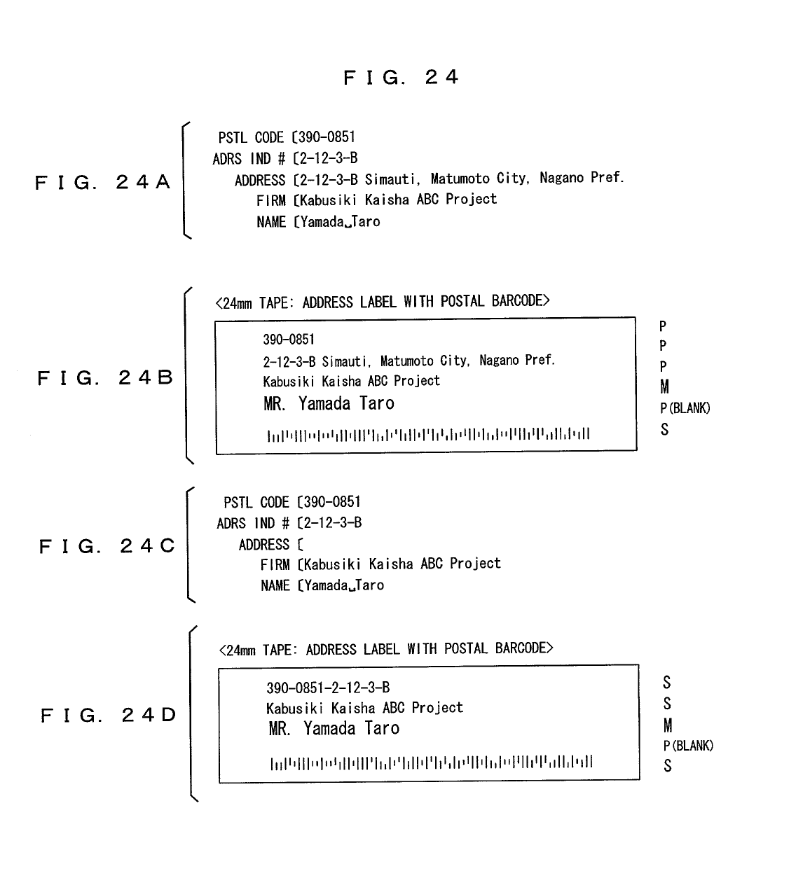

For instance, in the state of the name “Yamada Taro” having been input (T32), or in the state of the entry of the barcode numerical value (“BARCODE”) information being prompted (T40), described hereinabove with reference to FIG. 9, when the conversion key 342 is depressed together with the shift key 327, the cursor K prompts the user to enter “ADRS IND #” (address indication number) (T50: commonly shown in FIGS. 9 and 11). Then, e.g. as shown in FIG. 11, from this state (T50), after operating the character key group 31 to input e.g. the character string (address indication number) “2-12-3-B” (see FIG. 16), if the user depresses the selection key 323, the cursor K prompts the user to enter “TEL1” (phone number 1) (T43: commonly shown in FIGS. 10 to 12). In the present embodiment, a barcode (i.e. barcode numerical value information) is included in entry items (registration items) of address information, and hence address indication numbers is also included in the entry items (registration items) since the barcode numerical value information contains the address indication number. Of course, since barcode numerical value information can be generated based on a postal code and an address indication number, at any time by setting an address indication number to an entry item (registration item) which should be directly input beforehand, a customer barcode may be generated by generating the barcode numerical value information immediately before generation of the customer barcode (see FIGS. 24A and 24B).

In the above cases, as described above, the tape printing apparatus 1 is constructed such that a seven-digit postal code indicating a postal administrative district/town area is input, and when a customer barcode is desired to be printed, an address indication number (which is a portion of barcode numerical value information) representative of a subordinate address portion further specific than the postal administrative district/town area is directly input by using a numerical value thereof. As will be described in detail hereinafter, if an address indication number has been input, a customer barcode is generated based on the postal code and the address indication number when an address printing operation for printing an address including the postal code on a tape (printing object) T is instructed, whereby the first address printing is carried out in response to the instruction, as a type of address printing for printing an address including the customer barcode, on the tape T, on condition that the barcode numerical value information has been entered before the instruction is provided (see S235 in FIG. 16, FIGS. 23A and 23B, and FIGS. 24A to 24D). Further, if the address indication number has not been entered, the second address printing is carried out as another type of address printing for printing an address without including a customer barcode, on the tape T (see S236 in FIG. 16, FIGS. 23C and 23D).

That is, if the new mail processing system is promoted to make the address indication number further generally known and cause printing of customer barcode to be put into more general use, the tape printing apparatus 1 can generate a customer barcode more easily from a directly entered address indication number and carry out the address printing for printing an address including the customer barcode, while reducing extra processing time or extra capacity of memory. Further, if no address indication number has been input, similarly to the conventional apparatus, address printing is carried out for printing an address without including a customer barcode, so that address printing in which no customer barcode is printed can be also executed. The selection between the two types of address printing can be easily made depending whether or not the address indication number has been entered.

It is also possible to contemplate that just as in the old mail (postal code) processing system in which so long as a postal code is written on a mail article, description of the name of a prefecture and the like can be omitted, in the new mail (postal code) processing system as well, if a postal code and an address indication number are written on a mail article, it becomes possible to omit description of an address or the like (see FIGS. 24C and 24D). Further, automation (mechanization) of mail processing has been developed to such an extent that if customer barcodes are printed on mail articles, the mail articles can be automatically (mechanically) aligned in the order of delivery, and in the above case, there occurs no problem in omitting description of an address or the like. Therefore, the tape printing apparatus 1 is configured such that entries of addresses can be omitted to simplify the entry process.

For instance, in the state of the entry of a postal code having been completed (T25), as described above with reference to FIG. 8, when the conversion key 342 is depressed together with the shift key 327, the entry of an address is omitted, and next the cursor K prompts the user to enter “FIRM” (firm name) (T30: commonly shown in FIGS. 8 and 9). It should be noted that in the tape printing apparatus 1, in a state of entry to each entry item (each registration item) being prompted, when the selection key 323 is simply depressed with no entry via the character key group 31 being made, entry to the entry item is omitted. Accordingly, the above postal code, address, firm name, personal name and the like can be omitted so long as (on condition that) the address of a receiver of the mail article is made definite by other information. For instance, in the state of the entry of “ADDRESS” (postal address) being prompted (T26) described above with reference to FIG. 8, when the selection key 323 is depressed, the entry of the postal address is omitted, and next the cursor K prompts the user to enter “FIRM” (firm name) (T30: commonly shown in FIGS. 8 and 9). Since the following operations and processing are the same as those carried out when the entry of the postal address is not omitted (the case shown in T29), detailed description thereof is omitted (see FIG. 9).

It should be noted that the tape printing apparatus 1 may be configured such that in the case of the entry of the postal address being omitted, when the user is prompted to enter “BARCODE” (barcode numerical value information) (T40: commonly shown in FIGS. 9 and 10) or when he is prompted to enter “ADRS IND #” (address indication number) (T50: commonly shown in FIGS. 9 and 11), if he depresses the selection key 323 while omitting the entry of the barcode numerical value information or the entry of the address indication number, the apparatus can prompt the user to enter the barcode numerical value information or the address indication number without fail by ignoring the entry via the selection key 323 or notifying the user of the occurrence of an error. Further, similarly, the tape printing apparatus 1 may be configured such that in the state of the entry of “PSTL CODE” (postal code) being prompted (T22), as described above with reference to FIG. 7, when the selection key 323 is depressed, that is, when the entry of the postal code is omitted, the apparatus prompts the user to enter the barcode numerical value information or the address indication number without fail by ignoring the operation of the selection key 323 or notifying the user of the occurrence of an error.

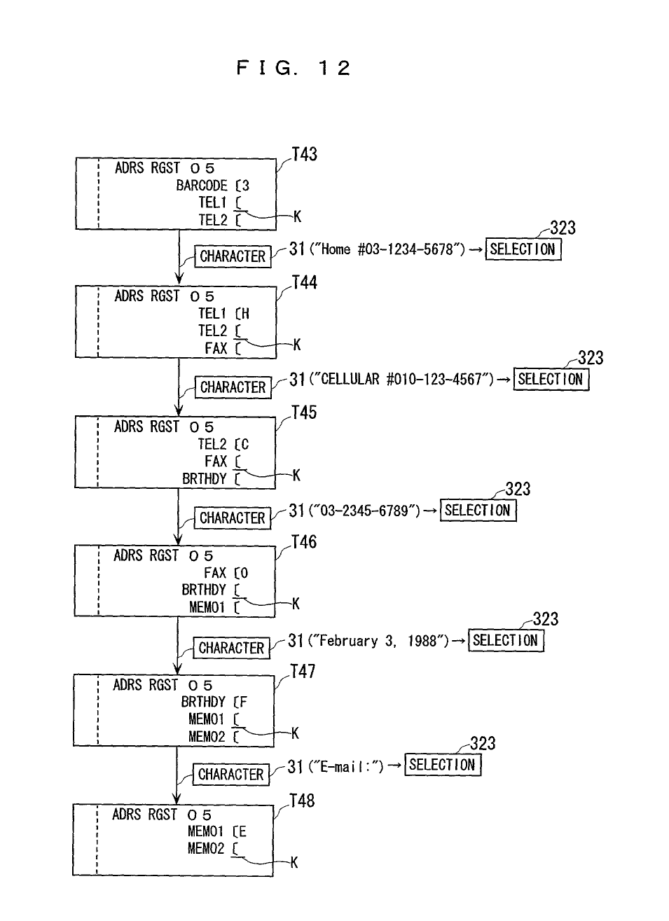

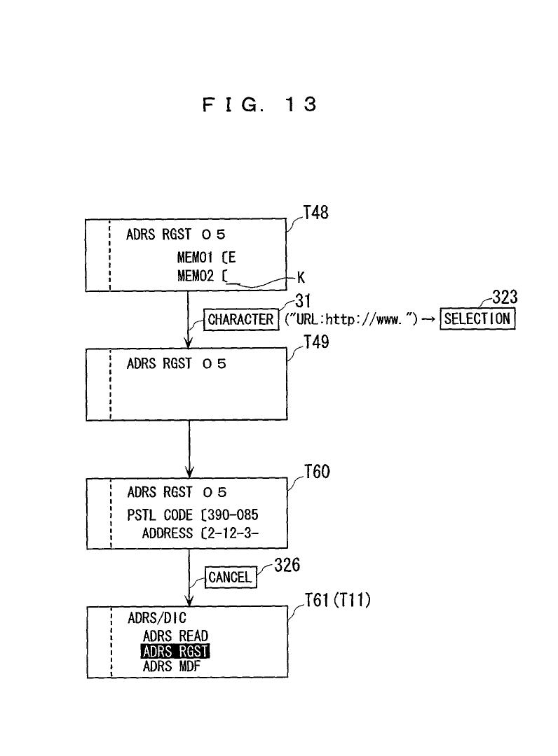

Next, for instance, as shown in FIG. 12, from the state of the entry of “TEL1” (phone number 1) being prompted (T43: commonly shown in FIGS. 10 to 12), when the user operates the character key group 31 to enter a character string (TEL1) “Home 03-1234-5678”, for instance, and depresses the selection key 323, next the cursor K prompts the user to enter “TEL2” (phone number 2) (T44). From this state (T44), when the user operates the character key group 31 to enter a character string (TEL2) “Cellular 010-123-4567”, and depresses the selection key 323, the cursor K prompts the user to enter “FAX” (facsimile number) (T45). From this state (T45), when the user operates the character key group 31 to enter a character string (FAX) “03-2345-6789”, for instance, and depresses the selection key 323, the user is prompted next to enter “BRTHDY” (birthday), by the cursor K (T46) From this state (T46), when the user operates the character key group 31 to enter a character string (birthday) “Feb. 3, 1998”, for instance, and depresses the selection key 323, the user is prompted to enter “MEMO1” (T47). From this state (T47), when the user operates the character key group 31 to enter a character string (MEMO1) “E-mail:” and depresses the selection key 323, the user is prompted to enter “MEMO2”, by the cursor K (T48: commonly shown in FIGS. 12 to 13).

Next, e.g. as shown in FIG. 13, from the state of the entry of “MEMO2” being prompted (T48: commonly shown in FIGS. 12 to 13), when the user operates the character key group 31 to enter a character string (MEMO2) “URL: http://www.”, for instance, and depresses the selection key 323 the whole entry process of the address registration has been terminated to execute the registration, and a message notifying the user of the fact is displayed (T49) . After the registration has been terminated, a confirmation screen for confirming registered address information is displayed (T60). In this state (T60), the user operates the cursor key 330 and scrolls the display screen to thereby confirm all the address information. After terminating the confirmation, by operating the cancel key 326, the user can change the confirmation screen to the selection Act screen at the upper level in hierarchy (first hierarchical level) (T61: the same as T11 in FIGS. 5 and 6).

Further, although in the present embodiment, as described above, the confirmation screen for confirming registered address information is displayed (T60) after the address registration is terminated, and the confirmation screen is switched to the selection screen at the upper level in hierarchy, when the cancel key 326 is operated, this is not limitative, but the confirmation screen may be switched (returned) to the selection screen at the upper level (first hierarchical level) in hierarchy upon completion of the registration processing, or alternatively the confirmation screen may be directly switched (returned) to the text entry screen (T10 in FIGS. 5 and 6). In the present embodiment, however, the confirmation screen (T60) is displayed, thereby enabling the address information to be confirmed immediately after the registration, and further the confirmation screen is switched (returned) to the “ADRS/DIC” (address/dictionary) selection screen (T61: the same as T11 in FIGS. 5 and 6) at a level hierarchically immediately above the same (first hierarchical level), so that if the address information is desired to be modified or corrected, the option “ADRS MDF” (address modification) can be selected to select a registration number of address information to be modified or corrected, in the same manner as described above in the “ADRS RGST” (address registration) (the same as T20 and T21 in FIG. 6, only registration numbers already registered are provided as options), and then similarly to the case of the above confirmation screen being displayed (T60), the display screen is scrolled by operating the cursor key 330 to specify a portion to be modified by the cursor K, thereby permitting the portion to be modified. Further, when address information is desired to be confirmed or checked again, the option “ADRS READ” (address reading) is selected, and after selecting a registration number of address information to be modified (only registration numbers already registered are provided as options), the cursor key 330 is operated to scroll the display screen, whereby confirmation can be carried out. Further, when an address printing operation is desired to be executed immediately after terminating the confirmation, address printing can be carried out by selecting the option “ADRS PRNT” described hereinbelow, and selecting all or part of address information already registered selected by selecting corresponding registration numbers of information (only registration numbers already registered are provided as options).

As described above, in the new mail processing system, it is possible, in principle, to generate a customer barcode if only a seven-digit postal code and an address indication number are provided. Further, in the tape printing apparatus 1, address information including an entry of postal code can be registered or recorded, and the address information is configured such that it can contain an address indication number. As described hereinafter, the instruction of address printing is given after information of an address to be printed is read out, and the first address printing is carried out when the information of the address to be printed includes an address indication number. That is, in this case, since the postal code and address indication number are provided as address information, it is possible to produce a customer barcode with ease to carry out address printing to print an address including the customer barcode. Further, since such address information can be registered beforehand, an address printing operation can be instructed and executed by reading out address information of the address to be printed, irrespective of whether or not the time point of the giving instruction is immediately after the entry of the postal code and the like of the address. Further, the address printing operation for printing the same destination can be repeatedly carried out as required.

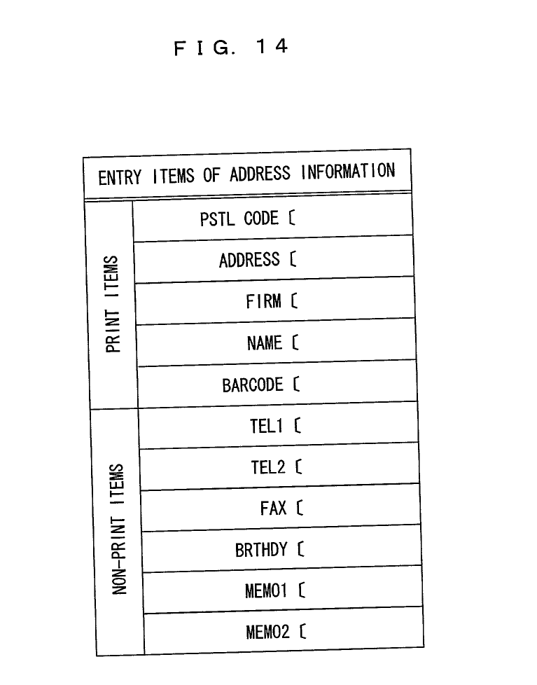

Further, as described hereinbefore, in the tape printing apparatus 1, it is possible to modify and confirm (read) address information. That is, address information registered can be modified by selecting the option “ADRS MDF” (address modification), which contributes to enhancement of the operability and usefulness of the apparatus. Further, the address information contains not only information to be printed by an address printing operation but also collateral information not to be printed by the same. In the present embodiment, as shown in FIG. 14, address information to be printed (print items) includes an address (expressed by characters), firm (firm names), a personal name in addition to a postal code, an address indication number (or barcode numerical value information), while collateral information (non-print items) includes phone numbers, (TEL1, TEL2), a fax number (FAX), a birthday, and other memoranda (MEMO1, MEM2: E-mail address and the like). In other words, it is possible to read all address information including collateral information on the above confirmation screen and by selecting the option “ADRS READ” (address reading) and thereby grasp information (non-print items) as to an address other than information for printing (print items). Hence, it is possible to store (take notes of) information (non-print items) desired to be stored as collateral information and refer to the same as required, so that the tape printing apparatus 1 can be made use of as a device having a memorandum-storing function.

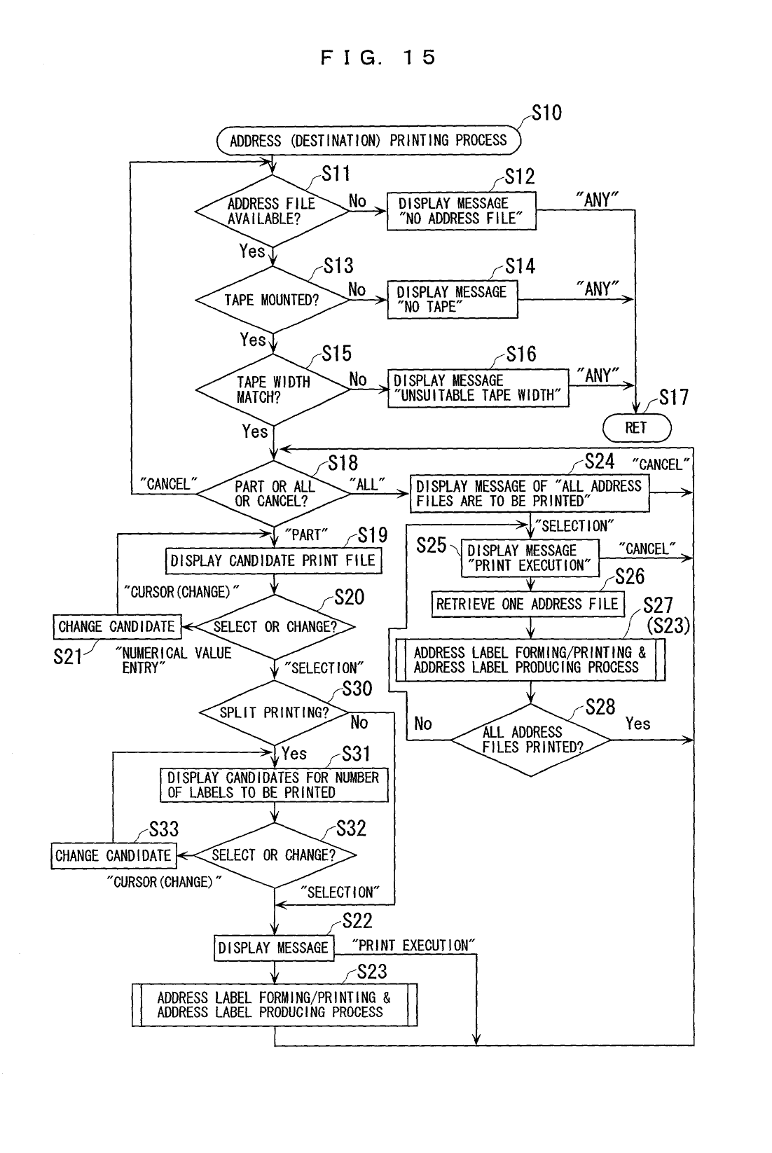

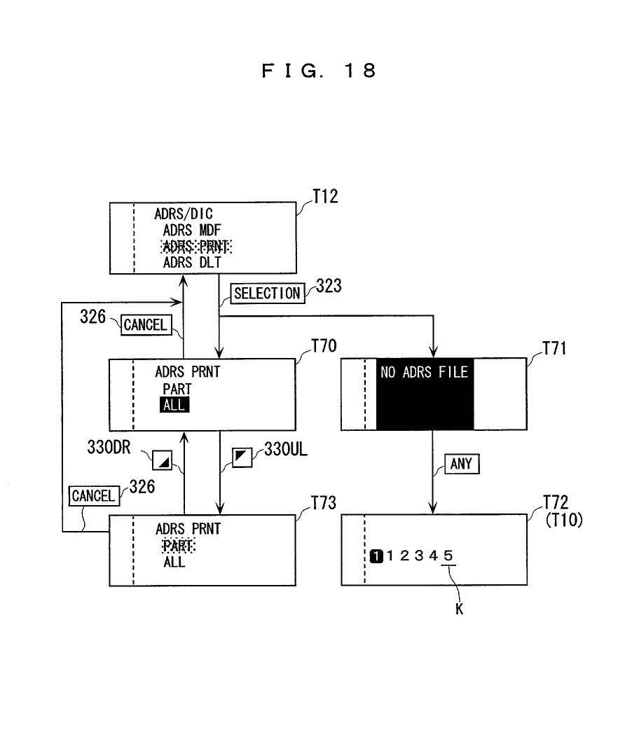

Next, address (destination) printing will be described hereinafter. FIG. 15 shows a flowchart showing a flow of an address (destination) printing process. For instance, as shown in FIG. 18, in the state of the option “ADRS PRNT” (address printing), described above with reference to FIG. 5, being highlighted for selection (T12: commonly shown in FIG. 5), if the selection key 323 is depressed by the user, the option “ADRS PRNT” (address printing) is selected to start the FIG. 15 address printing process, and the screen is switched to a selection screen at the second hierarchical level positioned under the option of “ADRS PRNT” for selecting an object to be printed by the address printing operation (T70). On this selection screen, an option “PART” or “ALL” is displayed as an option for selecting an object to be printed in reverse video or in the flashing state. For instance, in the case of the illustrated example, first, the option “ALL” which has been accessed on the immediately preceding occasion is displayed in reverse video (T70).

As shown in FIG. 15, however, when the address printing process is started, first, it is determined (S11) whether or not there is a file (address file) registered by address registration. If there is no available address file (No to S11), a message notifying the user of the fact is displayed (S12, T71). In this state (S12, T71), by depressing any key (shown as “ANY” in FIG. 15 and other similar figures), the user can terminate the processing to return the display screen to the text entry screen (T72: the same as T10 in FIG. 5). It should be noted that in this case, the screen may be returned to the state of the option “ADRS PRNT” (T12, also shown in FIG. 5) being highlighted for selection so as to allow the user to carry out the above “ADRS RGST” with ease after termination of the above processing.

On the other hand, if an address file exists (Yes to S11), next, it is determined based on a tape-discriminating signal indicative of the type of tape T sensed by the tape-discriminating sensor 142 of the sensor block 142 (S13), whether or not a tape T (actually tape cartridge C) is mounted in the tape printing apparatus. Then, it is determined (S15) whether or not the mounted tape T is any one of the tapes T defined as types of tapes for use in the address printing and having tape widths of 24 mm, 18 mm, 12 mm, 9 mm, and 6 mm, that is, whether or not the mounted tape T has a tape width matching one of the predetermined tape widths. If no tape T is mounted (No to S13), a message notifying the user of the fact (that there is no tape mounted) is displayed (S14), whereas if there is mounted a tape T but the width of the tape T does not match any of the predetermined tape widths (No to S15), a message notifying the user of the fact (that the tape width of the mounted tape does not match i.e. the tape is not suitable) is displayed (S16). In the above states (S14, S16), similarly to the above-mentioned state (S12, T71) in which there is no address file, the user can terminate the processing by depressing any key to return the display screen to the text entry screen. If there exists an address file and the mounted tape T has a tape width matching one of the predetermined tape widths (Yes to all of S11, S13 and A15), the option “ALL” selected in the immediately preceding occasion is displayed in reverse video (T70 in FIG. 18) on the selection screen at the second hierarchical level positioned under the option of “ADRS PRNT”, where an object to be printed by the address printing operation should be selected.

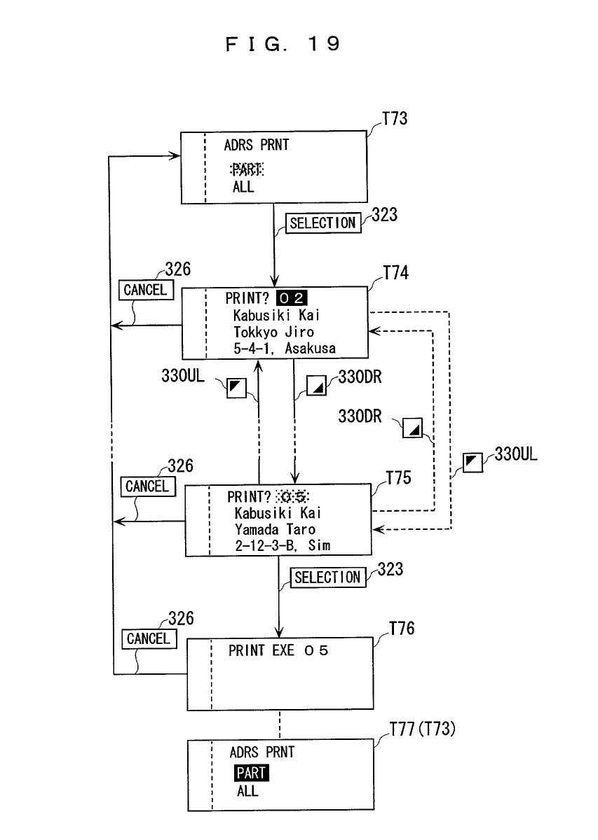

Next, as shown in FIGS. 15 and 18, in the state in which the selection screen at the second hierarchical level positioned under the option of “ADRS PRNT” is displayed, the user can (cyclically) highlight a desired option (“PART” or “ALL” in this example) for selection (T70, T73: T73 is also shown in FIG. 19) by operating the cursor key 330, and select the desired option by operating the selection key 323 (S18: “PART” or “ALL”). Further, the user also can switch the selection screen to the selection screen positioned at the first hierarchical level by depressing the cancel key 326 (S18: “CANCEL”).

Next, as shown in FIGS. 15 and 19, when the selection key 323 is depressed in the state of the option “PART” being highlighted for selection (S18: “PART”) (T73), the screen is switched to a selection screen for selecting an address file (print file) to be printed, which is at the third hierarchical level positioned under the option of “ADRS PRNT” (T74). In this case, first, an address file accessed or selected on the immediately preceding occasion is highlighted for selection as a print file (T74), and the user can (cyclically) highlight a desired option for selection by operating the cursor key 330 (S19 to S21, T74 to T75), and select the desired option by operating the selection key 323 (S20, “SELECT”). In the illustrated example, the user can highlight an address file having a registration number “05” for selection (S19 to S21, T75), and select the same by operating the selection key 323 (S20: “SELECTION”) . It should be noted that in this case it is possible to directly input a desired registration number (“05” in this example) by operating a number key group 313 instead of operating the cursor key 330 and highlight a desired option (address file having a registration number “05”) (T75) for selection [S20: “INPUT VAL” (input value)].

By the way, in the present embodiment (tape printing apparatus 1), the tape T having the tape width of 24 mm and used in describing examples illustrated in FIGS. 5 to 14 is defined as a tape T having the specific tape width (first tape width) (see FIGS. 21 to 22). When the mounted tape T has the specific tape width of 24 mm, by printing all items required for forming an address as a single block and cutting off the printed block (i.e. portion of the tape printed with the block), it is possible to produce an address label which is printed with all information items of the address thereon, and at the same time has a size suitable for being affixed to a mail article (see FIGS. 23A to 23D).

Therefore, as shown in FIGS. 15 and 19, in the state of an arbitrary address file (e.g. address file having the registration number “05” in the illustrated example) is highlighted for selection as a candidate for a print file (S19, T75), if the selection key 323 is depressed (S20, “SELECT”), it is determined then whether or not a split printing process should be carried out (S30). If the tape width (detected tape width) of the mounted tape T is 24 mm, it is determined that the split printing process is not to be executed (No to S30), and a message notifying the user of execution of a printing operation is displayed (S22, T76). Then, an image to be printed by the address printing is formed as a print image, and the image is printed on the tape T by the address printing, followed by cutting off the printed portion of the tape T to produce an address label (address image forming/printing & address label producing process: S23). After completion of the process, the screen is switched to the selection screen at the upper level in hierarchy (second hierarchical level) (T77: the same as T73, however, displayed in reverse video this time since the option “PART” was accessed or selected on the immediately preceding occasion). It should be noted that the message notifying the user of execution of the address printing continues to be displayed during execution of the address image forming/printing & address label producing process (S23), and in the meanwhile the user can interrupt the execution thereof by operating (depressing) the cancel key 326 to switch (return) the screen to the selection screen (T73) at the second hierarchical level.

On the other hand, in a state in which the option “ALL” is highlighted for selection as an object to be printed, on the selection screen at the second hierarchical level (T70 in FIG. 18), if the selection key 323 is depressed (S18 in FIG. 15: “ALL”), as shown in FIG. 15, a message is displayed for prompting the user to confirm that all the address files are set to files to be printed (print files) (S24). Even at this time point, the user can interrupt the execution of the address printing by depressing the cancel key 326. Further, after the user has confirmed that all the address files are set to print files, if the selection key 323 is depressed (S24: “SELECT”), the message notifying the user of execution of the address printing is displayed (S25), and continues to be displayed until completion of the address printing process to print all the address files.

In the address printing process for printing all the address files, each address file is retrieved (read out) in the order of registration (S26), the address image forming/printing & address label producing process are carried out on the address file (S27: the same as S23), and it is determined whether or not printing of all the address files has been completed (S28). If the printing has not yet been completed (No to S28), the same loop as described above continues to be carried out on the next address file. That is, the display of the message notifying the user of execution of the address printing (S25), the reading out of each address file (S26), the address image forming/printing & address label producing process (S27), and the determination of completion of the address printing process are carried out, and after all the address files have been printed (Yes to S28), the screen is switched to the selection screen at the second hierarchical level (the same as T70). Of course, in the meanwhile the user can interrupt the execution of the printing processing by operating (depressing) the cancel key 326.

In the above destination image forming/printing & address label producing process [S23 (S27)], as shown in FIG. 16, first, the print items (see FIG. 14) of entered (registered) address information are recognized (S231). If “NAME” (personal name) is included therein (if “NAME” is not omitted), “Mr. or Mrs. ” is added, and if “FIRM” (firm name) is included therein (if “FIRM” is not omitted), “Messrs.” is added (S232) . Further, both “FIRM” and “NAME” are included, “Messrs.” may be omitted.

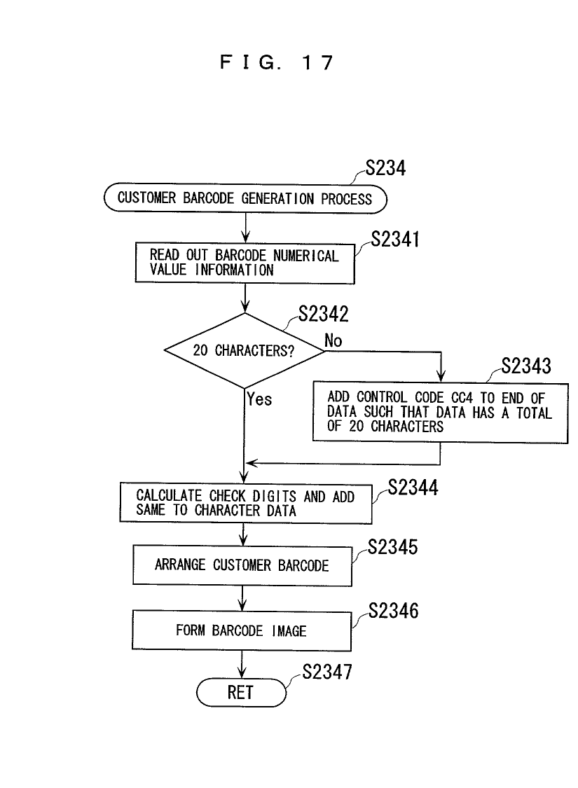

Next, it is determined whether or not “BARCODE” (barcode numerical value information) is included (S233). If barcode numerical value information is included (Yes to S233), next, a barcode image required for printing a customer barcode is generated (customer barcode generation process: S234). When this customer barcode generation process (S234) is started, as shown in FIG. 17, first, the barcode numerical value information is read out (S2341), and it is determined whether or not the barcode numerical value information contains 20 characters (S2342). If the barcode numerical value information contains characters smaller in number than 20 characters (No to S2342), a control code CC4 is added to the end of the characters (S2343) to produce character data for a barcode. Then, check digits (CD) are calculated and added to the character data (S2344), a customer barcode is arranged based on the data (S2345), and a barcode image is formed based on a barcode font, such as bit map data, for the characters (S246), followed by terminating the processing (S2347).

As shown in FIG. 16, after termination of the customer barcode generation process (S234), for instance, a print image for use in the address printing (see FIGS. 23A and 23B) for printing an address inclusive of a customer barcode is formed based on character sizes (first destination character size) which are defined in a section of tape width of 24 mm in a block-by-block print items table FIG. 21, and printed on the tape T. Then, the printed portion of the tape T is cut off to thereby produce an address label printed by the first address printing (first address printing: S235), followed by terminating the processing (S23)(S237).

On the other hand, if barcode numerical value information is not included in the print items (No to S233), for instance, a print image for use in the address printing (see FIGS. 23C and 23D) for printing an address without a customer barcode is formed based on a character size (second destination character size) which is defined in a section of tape width 24 mm in a block-by-block print items table FIG. 22, and printed on the tape T. Then, the printed portion of the tape T is cut off to produce an address label printed by the second address printing (second address printing: S236), followed by terminating the processing (S23)(S237).

Further, as described above, since barcode numerical value information can be generated based on a postal code and an address indication number, the apparatus may be configured such that an address indication number is an item for direct entry, and a customer barcode is generated by obtaining barcode numerical value information immediately before generation of the customer barcode (see FIGS. 24A and 24B). In this case, when the address indication number has been already input (corresponding to Yes to S233), the first address printing is carried out to print an address with a customer barcode (corresponding to S235 in FIG. 16, see FIG. 21, FIGS. 23A and 23B, and FIGS. 24A to 24D), whereas when the address indication number has not been input or registered (corresponding to No to S233 in FIG. 16), the second address printing is carried out to print an address with no customer barcode (corresponding to S236 in FIG. 16, see FIG. 22, FIGS. 23C and 23D).

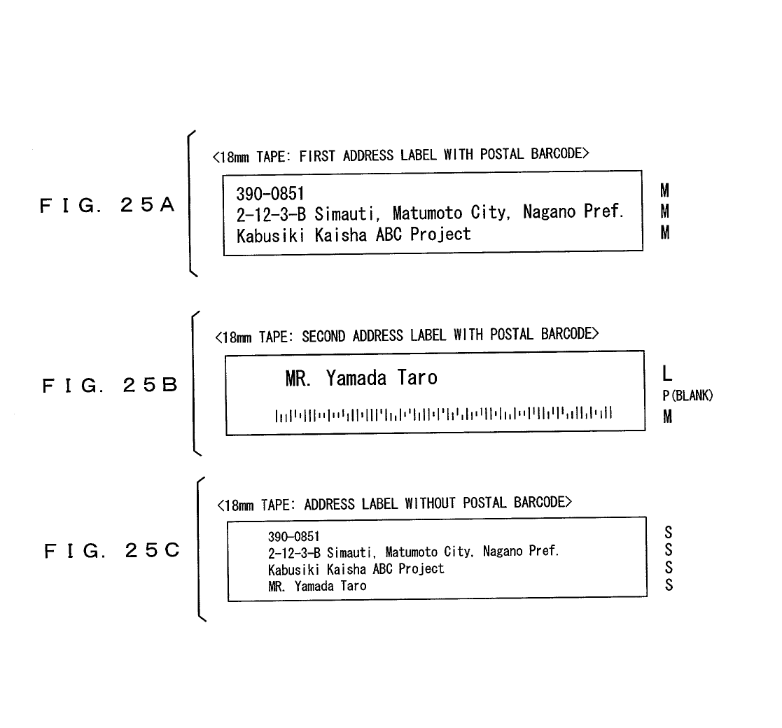

Next, address printing carried out on a tape T mounted which does not have the specific tape width of 24 mm, that is, address printing carried out on a tape T having a tape width e.g. of 18 mm will be described hereinafter. Basically, the address printing in this case can be carried out in two different ways. That is, as shown in FIGS. 21 and 22, when a customer barcode (postal barcode) is printed (by the first address printing), address information is printed as two blocks by split printing to thereby form two pieces of address labels (see FIGS. 25A and 25B), whereas when address information without a customer barcode (postal barcode) is printed (by the second address printing), the information is printed as a single block without effecting split printing to thereby form a single address label (see FIG. 25C).

For instance, in the former case (in a case of postal barcode provided), as shown in FIG. 21 and FIGS. 25A and 25B, address information is printed as two blocks by split printing, and after printing, each block (portion of the tape printed with the block) is automatically cut off at a trailing end thereof (when there is a next block to be printed, at a boundary between the printed block and the next one) to thereby produce two pieces of (address) labels. In this case, a first block (portion to be a first address label) is comprised of images of the items of the postal code, the postal address, and the firm name, while a second block (portion to be a second address label) is comprised of images of the items of the personal name and the barcode, so that if the two blocks (portions of the tape printed with the blocks) are cut off into two address labels, and affixed to a mail article in a properly arranged manner, they can be employed to form an address label which is as excellent as an address label having a width of 24 mm, shown in FIG. 23A (or more excellent than the same in that the user can design a variety of layouts in affixing them).

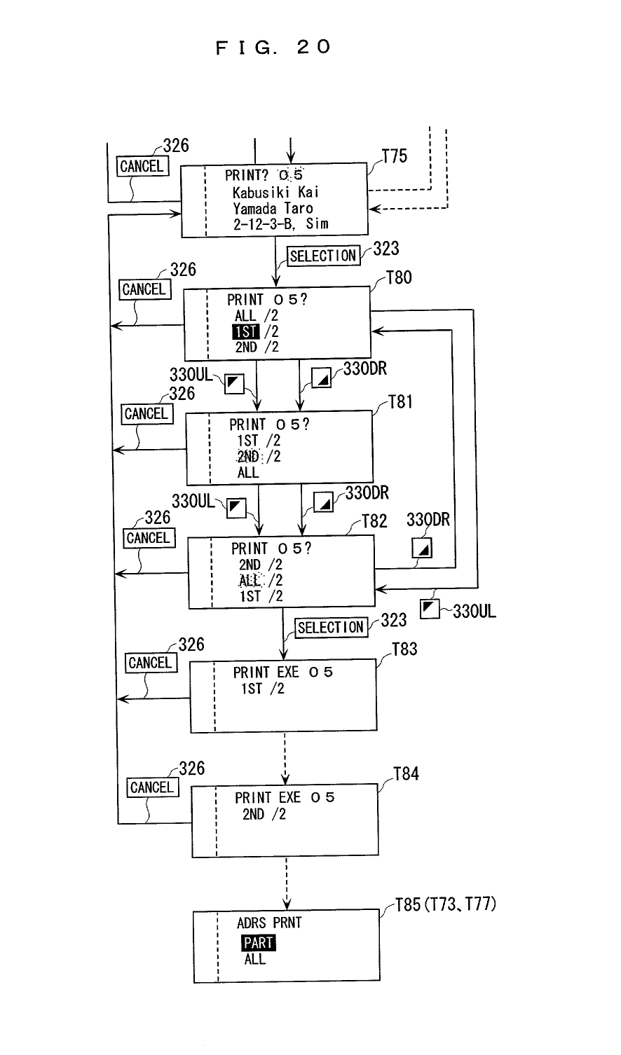

As described hereinbefore, in the case of the tape T which does not have the specific tape width of 24 mm (which has a tape width of 18 mm, for instance) being mounted, as shown in FIGS. 15 and 19, in the state of an arbitrary address file (e.g. address file having the registration number “05” in this example) being highlighted for selection as a candidate for a print file (S19, T75: commonly shown in FIG. 20), if the selection key 323 is depressed (S20, “SELECT”), it is determined whether or not split printing process is to be carried out on the tape T (S30). Now, the address file exists, the tape width (second tape width) is 18 mm which is included in the predetermined tape widths, and a postal barcode exists, and hence split printing (see FIG. 21) should be carried out on the tape T (Yes to all of S11, S13, S15 and S30), and as shown in FIG. 15 and 20, the screen is switched to a selection screen for selecting the number of labels to be printed (S81, T80). In this case, first, an option accessed on the immediately preceding occasion is highlighted for selection as a candidate for the number of labels to be printed (T80), and the user (cyclically) can highlight a desired option for selection (S31 to S33, T80 to T82) by operating the cursor key 330 (S32: “SELECT”).

Referring to FIGS. 15 and 19, for instance, after the option “ALL” (ALL/2, all of the two) is highlighted for selection (T82), if the selection key is operated for selection (“ALL” is selected), a message that printing of “1ST/2” (first of all the two labels) is executed is displayed (S22, T83), an image for address printing is formed as a print image, and the address printing is carried out on the tape T. After printing, the printed portion of the tape T is cut off to produce an address label [address image forming/printing & address label producing process (S23: see FIG. 25A)]. Then, a message notifying the user that printing of “2ND/2” is executed is displayed (S22, T84), an address image is formed for printing, the printed portion of the tape T is cut off to produce an address label [address image forming/printing & address label producing processing (S23: see FIG. 25B)], and the screen is switched to the selection screen at the upper level (second hierarchical level) in hierarchy (T85: the same as T77 in FIG. 19).

It should be noted that the messages (T83, T84) notifying the user of execution of the address printing continue to be displayed during execution of the address image forming/printing & address label producing process (S23), and in the meanwhile the user can interrupt the execution thereof by operating (depressing) the cancel key 326 to switch (return) the screen to the selection screen (T75) for selecting a candidate for a print file. Further, although in the above example, the option “ALL” (“ALL/2”) was selected (the selection key 323 was depressed at T82), this is not limitative, but e.g. if the option “2ND” (“2ND/2”) is selected, naturally, only the message therefor (T84) is displayed. Further, although in the above example, each block (portion of the tape printed with the block) was automatically cut off, this is not limitative, but all the blocks (two blocks in the above example) having cut marks added thereto may be cut off with scissors after printing. Further, for instance, after execution of printing of the first block (T83), a message saying “CUT OFF” for prompting the user to manually cut off the first block may be displayed such that each block can be manually cut off whenever printing thereof has been terminated. After the printed block is cut off by the user operating the cutting button 133, the next printing operation is started for printing the next block (second piece).

As described above, in the tape printing apparatus 1, a tape T for printing is mounted, and the tape width of the mounted tape T is detected. Further, n items of information (n is an integer equal to or larger than 2) which are components of an address of a mail article are registered in advance as address information and address printing for printing the address can be instructed. For instance, in the above example, as shown in FIG. 21, by registering information of the following five (n=5) items: a postal code, a postal address, a firm name, a personal name, and a barcode beforehand as address information as described above with reference to FIGS. 8 to 14 and the like, address printing can be instructed as described hereinabove with reference to FIGS. 18 to 20. Here, if the detected tape width is the specific tape width (first tape width) of 24 mm, when address printing is instructed, as shown in FIGS. 23A and 23B, it is possible to arrange the item images indicative of information of the respective five (n=5) items as the lines of a single block, thereby printing the block on the tape T having the first tape width (specific tape width) of 24 mm.

Further, if the detected tape width is not the specific tape width (first tape width) of 24 mm, if it is, for instance, a tape width (second tape width) of 18 mm, when address printing is instructed, the respective item images indicative of information of the five (n=5) items are grouped into m blocks (m is an integer defined as 2≦m≦n: in this example, m=2 as defined in the FIG. 21 table) based on the address information, and the grouped item images are each arranged as a corresponding one of lines in k blocks (k is an integer defined as 1≦k≦m: in this example, k =1 or 2) of the two (m=2) blocks, and the one or two (k−1 or 2) blocks are printed on a block-by-block basis. More specifically, the item images can be grouped into two (m=2) blocks to print each of the blocks, so that even if the detected tape width is not the first tape width (specific tape width) of 24 mm, in other words, even if the mounted tape is a tape T having the second tape width (tape width e.g. of 18 mm, smaller than the first tape width), it is possible to carry out address printing on the tape T based on the address information. Therefore, an address printable on the tape T having the first tape width (specific tape width) of 24 mm can also be printed on a tape T having the second tape width (tape width e.g. of 18 mm, smaller than the first tape width).

Further, as described above with reference to FIG. 20, by selectively designating any of the k blocks (k is an integer defined as 1≦k≦m) out of the m blocks (m is an integer defined as 2≦m≦n) as printing blocks, it is possible to print any blocks ranging from a desired one of the m blocks to all of the m blocks arbitrarily as required. That is, only a required part of the registered destination can be printed. It should be noted that similarly to the illustrated example of the FIG. 22 table showing the number of labels (number of blocks) to be printed when address printing is instructed, print items and character size(s) which are defined by omitting the item of a barcode from the FIG. 21 table, a set of the number of labels (number of blocks) to be printed when the address printing is instructed, items and character size(s) can be separately or additionally determined for each case in which various item(s) is/are omitted. This enables, for instance, address labels corresponding to the examples (in each of which the item of a postal address is omitted) illustrated in FIGS. 24C and 24D to be produced by printing the same on a tape T having a tape widths of 18 mm or smaller tape width.

Further, in the tape printing apparatus 1, as 2 shown in FIGS. 21 and 22, a plurality of types of tape widths (four types of 18mm, 12 mm, 9 mm and 6 mm in the present embodiment) which can become the second tape width, described hereinbefore, are defined, and the block-by-block print items table is provided which defines print items corresponding to respective lines of each block according to each tape width, so that by referring to the block-by-block print items table, it is possible to group the item images into blocks and arrange the item images as respective lines easily and suitably. Further, the block-by-block print items table stores an item image print size (referred to as a “character size” for purposes of convenience of description since the item image corresponds to a character size when the item image is a character string image) which defines the print size of each item image in the direction of the width thereof. By referring to the character size (size of each item image in the direction of the width thereof) appropriately defined, it is possible to easily print each item image in an appropriate size and hence an address in an appropriate size.

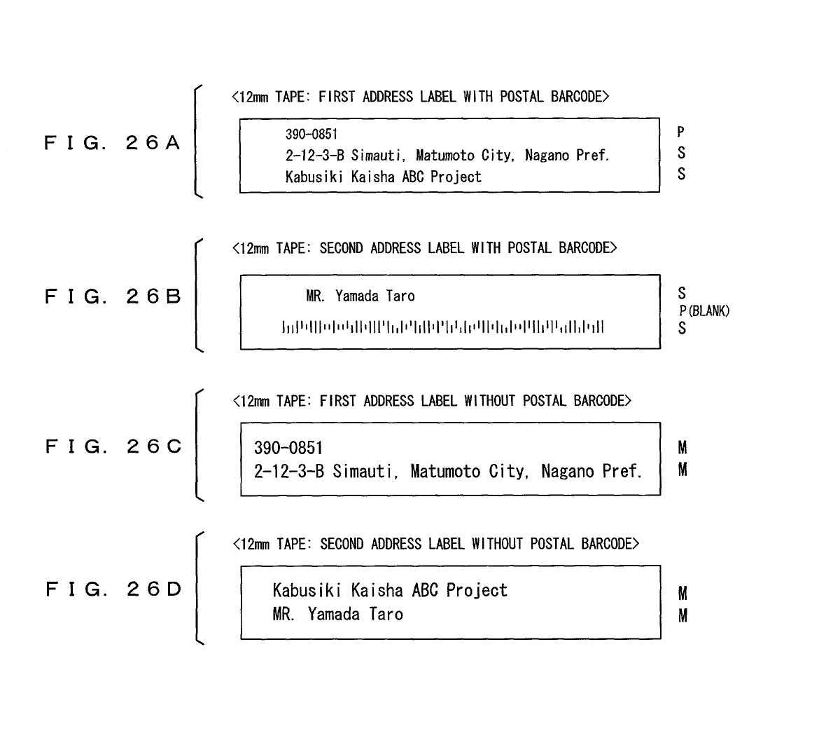

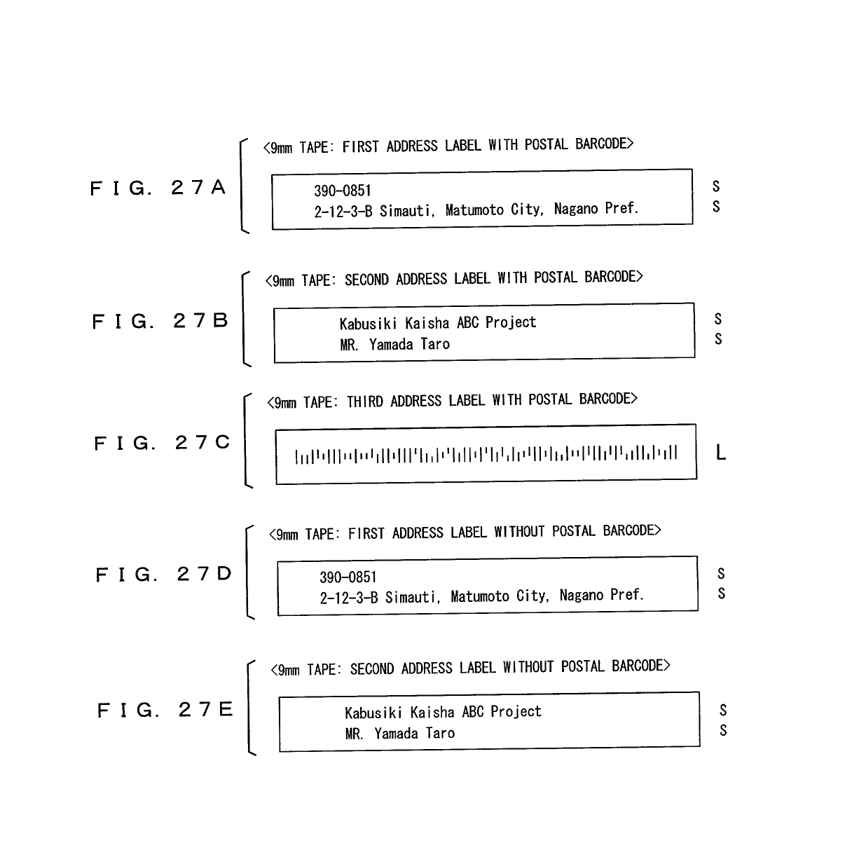

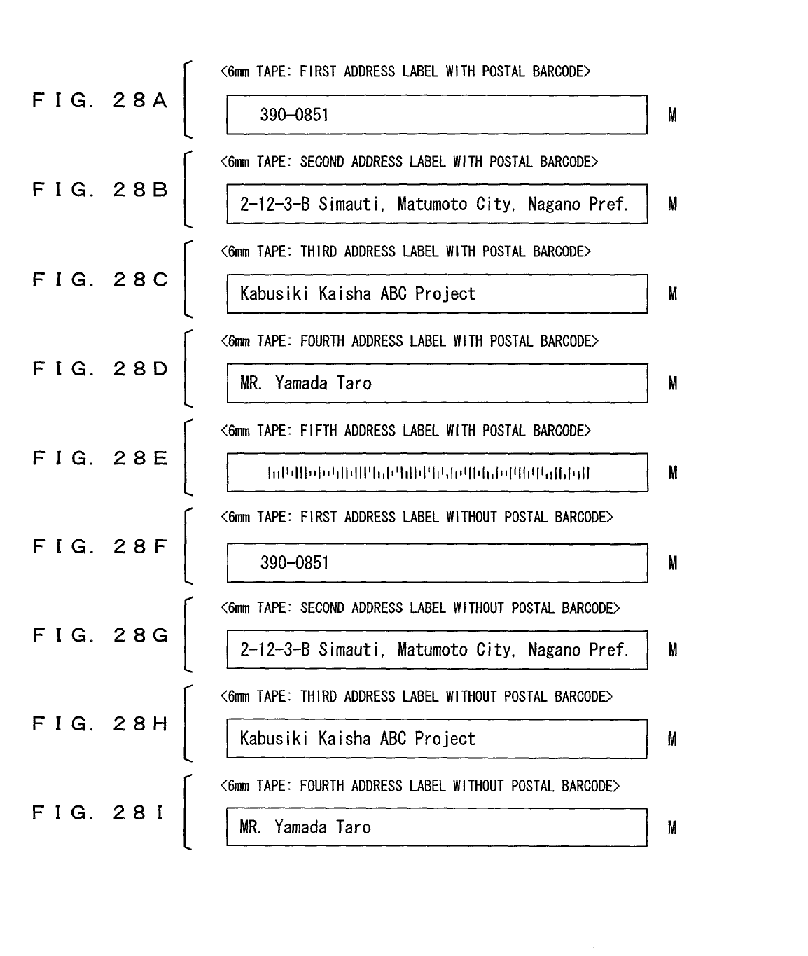

Therefore, an address printable on the tape T having the first tape width (specific tape width) of 24 mm can be appropriately printed on any of the tapes T having a plurality of second tape widths (smaller than the first tape width: 18mm, 12 mm, 9 mm and 6 mm in the present embodiment) (see FIG. 25A to FIG. 28I). Further, after printing, the printed block portion of the mounted tape is cut off from the tape T as an address label, thereby making it possible to produce an address label with ease. More specifically, when five (n=5) item images are printed on the tape T having the first tape width (specific tape width) of 24 mm, a single address label can be produced by printing the five (n=5) item images in one block, while when the five (n=5) item images are printed on a tape T having any of the second tape widths (tape widths smaller than the first tape width), m address labels can be produced by printing the five (n=5) item images in m blocks (m is an integer defined as 2≦m≦n: in the FIG. 21 example, m=2 to 5 in a manner corresponding to the tape width). Further, as shown in FIG. 20, only k blocks (k is an integer defined as 1≦k≦m) of the m blocks (m is an integer defined as 2≦m≦n), that is, only k pieces out of the m pieces can be formed into address labels. Therefore, it is possible to print and produce again only an address label erroneously affixed to a mail article, or alternatively to consciously change only a part (e.g. only a personal name) of an address label, thereby making an address label including only item images required by the user.

Further, in the tape printing apparatus 1, as described hereinabove with reference to FIG. 15, if the detected tape width is neither the first tape width (24 mm) nor any of the second tape widths (18 mm, 12 mm, 9 mm and 6 mm), a message notifying the user of the fact is displayed (S16) . Hence, the user can understand easily and quickly that appropriate address printing cannot be executed, and take measures to cope with the problem e.g. by replacing tapes. Further, as described above with reference to FIG. 19 or 20, the user is notified of a block which is being printed in response to the instruction of address printing, so that the user can grasp easily and promptly the block being printed. Further, even after an instruction of address printing has been given, it is possible to provide an instruction for canceling it through operating the cancel key 326, thereby stopping the following printing operation. Therefore, when the user is aware of his erroneous instruction of address printing, he can stop the address printing (before the start of or in the course of the printing operation) or after only a required portion of an address label has been printed, he can stop the printing operation subsequent thereto.

Further, in the tape printing apparatus 1, as described above with reference to FIG. 14 and the like, it is possible to register barcode numerical value information which is indicative of a numerical value to be represented by a customer barcode, as a portion of address information of a registered destination. As described hereinabove with reference to FIGS. 16 and 17, when address printing is instructed, it is determined whether or not the barcode numerical value information of the desired destination is registered. If it is determined that the barcode numerical value information is registered, addition of a barcode image (first address printing) is selected, and the barcode image is generated based on the registered barcode numerical value information, and hence it is possible to carry out address printing for printing an address having a barcode image added thereto simply by registering barcode numerical value information which is indicative of a numerical value to be represented by a customer barcode, as a portion of address information. In this case, as described above with reference to FIG. 11 and the like, barcode numerical value information may be registered in a manner divided into the information portion of a seven-digit postal code and that of an address indication number. The postal code can be set to the item (postal code) of an address as it is, and the address indication number can be set to the item of a number (e.g. house number) as a subordinate portion of a postal address, so that if the postal code and the address indication number are used as registered address information when the barcode image is printed, the capacity of memory can be saved by the amount of redundant information.

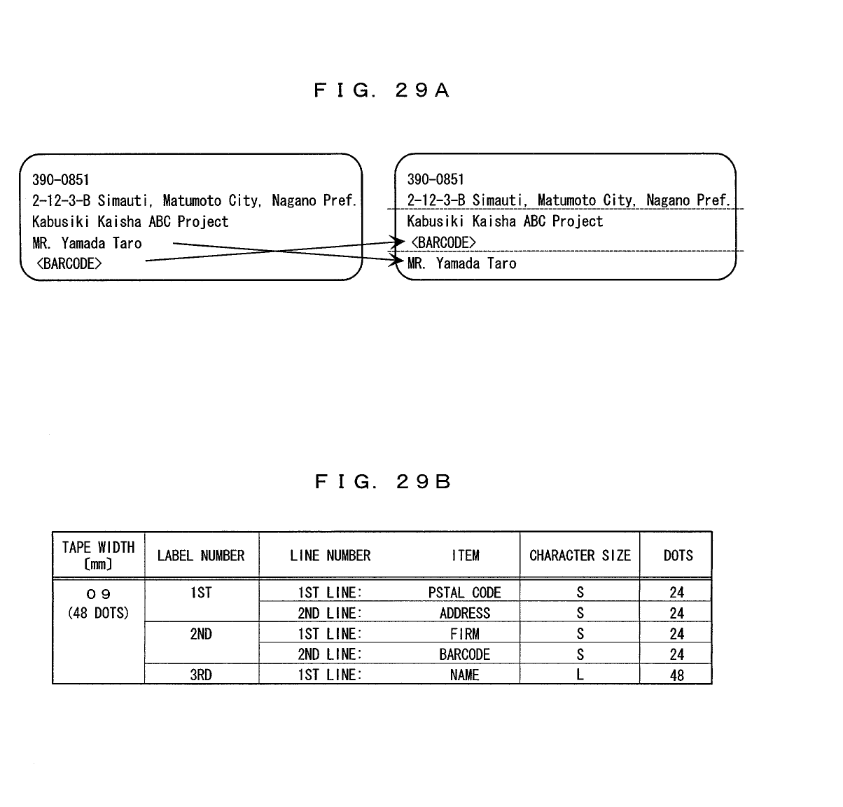

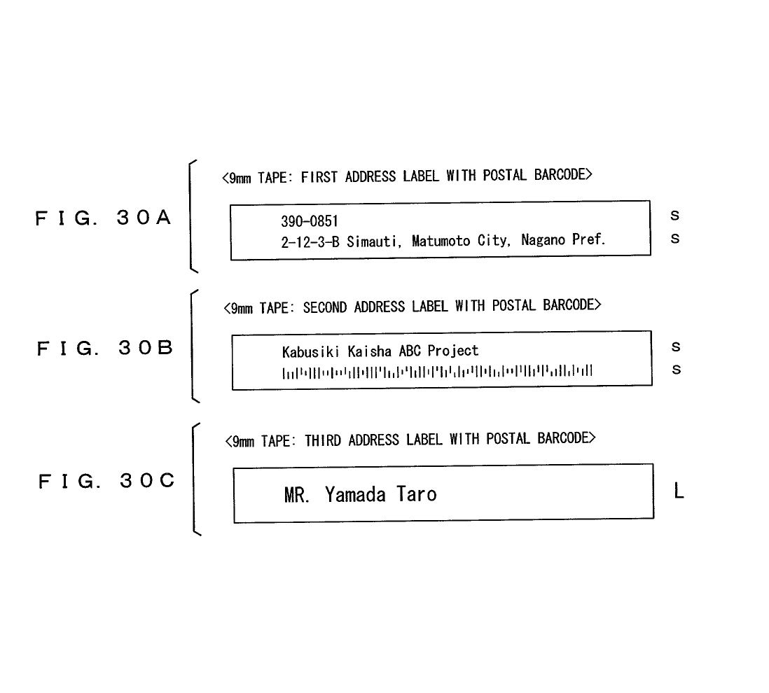

Further, the examples illustrated in FIGS. 25A to 28I are produced in accordance with the block-by-block print items table. Although item images are basically printed according to the order of the item images of the tape T which has the specific tape width (first tape width) of 24 mm, for instance, as shown in FIGS. 29A, 29B and 30A to 30C, when the tape width of a tape in use is different from the specific tape width (the examples illustrated in the figures show the case of a tape having a tape width of 6 mm being used), the order (of arrangement) of items (images) may be changed in view of degrees of importance of items (e.g. by putting emphasis on the name).

It is further understood by those skilled in the art that the foregoing is a preferred embodiment of the invention, and that various changes and modifications may be made without departing from the spirit and scope thereof.

What is claimed is:

1. An address printing method for a tape printing apparatus, comprising the steps of:
mounting a tape to be printed;
detecting a tape width of the mounted tape;
registering information of n items (n is an integer equal to or larger than 2) which are components of an address of a mail article, as address information;
instructing address printing;
arranging, in response to the instruction of the address printing, item images representative of information of the n respective items based on the address information as respective lines of a single block, and printing the single block, if the detected tape width is a first tape width; and
grouping, in response to the instruction of the address printing, the item images representative of information of the n respective items into m blocks (m is an integer defined as 2≦m≦n) based on the address information, arranging the grouped item images as respective lines of k blocks (k is an integer defined as 1≦k≦m) of the m blocks, and printing the k blocks on a block-by-block basis, if the detected tape width is a second tape width smaller than the first tape width.

2. An address printing method according to claim 1, further including the steps of:
selecting whether or not a barcode image representative of a customer barcode should be included in the item images representative of information of the n respective items, the customer barcode being formed based on a seven-digit postal code indicating a postal administrative district/town area and an address indication number representative of a subordinate address portion further specific than the postal administrative district/town area; and
generating, in response to the instruction of the address printing, the barcode image if it is selected that the barcode image should be included.

3. An address printing method according to claim 2, wherein barcode numerical value information which is indicative of a numerical value to be represented by a customer barcode can be registered as a portion of the address information, and
wherein the step of selecting whether or not a barcode image should be included, includes the steps of:
determining, in response to the instruction of the address printing, whether or not the barcode numerical value information has been registered; and
selecting that the barcode image should be included when it is determined that the barcode numerical value information has been registered, and
wherein the step of generating the barcode image includes generating the barcode image based on the barcode numerical value information.

4. An address printing method according to claim 3, wherein the barcode numerical value information is registered in a state decomposed into information of the seven-digit postal code and information of the address indication number.

5. An address printing method according to claim 1, further including the step of storing a block-by-block print items table which defines items corresponding to respective lines of each block to be printed in response to the instruction of the address printing.

6. An address printing method according to claim 5, wherein the step of storing the block-by-block print items table includes storing an item image print size defining a print size of each item image in a direction of a width of the tape, which item image corresponds to each line of each block to be printed.

7. An address printing method according to claim 5, wherein the second tape width includes a plurality of tape widths defined in advance,
wherein the block-by-block print items table defines the items corresponding to respective lines of each block to be printed, for each of the plurality of tape widths.

8. An address printing method according to claim 1, further including the step of notifying a user, in response to the instruction of the address printing, that the detected tape width is neither the first tape width nor the second tape width if the detected tape width is neither the first tape width nor the second tape width.

9. An address printing method according to claim 1, wherein the step of grouping the item images and printing the k blocks on a block-by-block basis when the detected tape width is the second tape width includes the step of designating the k blocks of the m blocks as blocks to be printed.

10. An address printing method according to claim 1, further including the step of notifying a user of a block which is being printed in response to the instruction of the address printing.

11. An address printing method according to claim 1, further including the step of being capable of giving an instruction for canceling the instruction of the address printing, thereby stopping a subsequent printing operation.

12. An address label producing method for a tape printing apparatus, comprising the steps of:
mounting a tape to be printed;
detecting a tape width of the mounted tape;
registering information of n items (n is an integer equal to or larger than 2) which are components of an address of a mail article, as address information;
instructing address printing;
arranging, in response to the instruction of the address printing, item images representative of information of the n respective items based on the address information as respective lines of a single block, and printing the single block, if the detected tape width is a first tape width;
grouping, in response to the instruction of the address printing, the item images representative of information of the n respective items into m blocks (m is an integer defined as 2≦m≦n) based on the address information, arranging the grouped item images as respective lines of k blocks (k is an integer defined as 1≦k≦m) of the m blocks, and printing the k blocks on a block-by-block basis, if the detected tape width is a second tape width smaller than the first tape width; and
cutting off a printed portion of the mounted tape as an address label.

13. An address printing device for a tape printing apparatus, comprising:
tape mounting means for mounting a tape to be printed;
tape width detection means for detecting a tape width of the mounted tape;
address registration means for registering information of n items (n is an integer equal to or larger than 2) which are components of an address of a mail article, as address information;
address printing instruction means for instructing address printing;
first tape width address printing means for arranging, in response to the instruction of the address printing, item images representative of information of the n respective items based on the address information as respective lines of a single block, and printing the single block, if the detected tape width is a first tape width; and
second tape width address printing means for grouping, in response to the instruction of the address printing, the item images representative of information of the n respective items into m blocks (m is an integer defined as 2≦m≦n) based on the address information, arranging the grouped item images as respective lines of k blocks (k is an integer defined as 1≦k≦m) of the m blocks, and printing the k blocks on a block-by-block basis, if the detected tape width is a second tape width smaller than the first tape width.

14. An address printing device according to claim 13, further including barcode addition selection means for selecting whether or not a barcode image representative of a customer barcode should be included in the item images representative of information of the n respective items, the customer barcode being formed based on a seven-digit postal code indicating a postal administrative district/town area and an address indication number representative of a subordinate address portion further specific than the postal administrative district/town area; and
barcode image generation means for generating, in response to the instruction of the address printing, the barcode image if it is selected that the barcode image should be included.

15. An address printing device according to claim 14, wherein barcode numerical value information which is indicative of a numerical value to be represented by a customer barcode can be registered as a portion of the address information, and
wherein the barcode addition selection means includes:
barcode numerical value information presence/absence determination means for determining, in response to the instruction of the address printing, whether or not the barcode numerical value information has been registered; and
barcode addition determination means for selecting that the barcode image should be included when it is determined that the barcode numerical value information has been registered, and
wherein the barcode image generation means generates the barcode image based on the barcode numerical value information.

16. An address printing device according to claim 15, wherein the barcode numerical value information is registered in a state decomposed into information of the seven-digit postal code and information of the address indication number.

17. An address printing device according to claim 13, further including block-by-block printed item storage means for storing a block-by-block print items table which defines items corresponding to respective lines of each block to be printed in response to the instruction of the address printing.

18. An address printing device according to claim 17, wherein the block-by-block printed item storage means includes block-by-block item image print size storage means for storing an item image print size defining a print size of each item image in a direction of a width of the tape, which item image corresponds to each line of each block to be printed.

19. An address printing device according to claim 17, wherein the second tape width includes a plurality of tape widths defined in advance, and
wherein the block-by-block print items table defines the items corresponding to respective lines of each block to be printed, for each of the plurality of tape widths.

20. An address printing device according to claim 13, further including nonconforming tape width notification means for notifying a user, in response to the instruction of the address printing, that the detected tape width is neither the first tape width nor the second tape width if the detected tape width is neither the first tape width nor the second tape width.

21. An address printing device according to claim 13, wherein second tape width address printing means includes printed block designation means for designating the k blocks of the m blocks as blocks to be printed.

22. An address printing device according to claim 13, further including printed block notification means for notifying a user of a block which is being printed in response to the instruction of the address printing.

23. An address printing device according to claim 13, further including address printing stop means which is capable of giving an instruction for canceling the instruction of the address printing, thereby stopping a subsequent printing operation.

24. An address label producing device for a tape printing apparatus, comprising:
tape mounting means for mounting a tape to be printed;
tape width detection means for detecting a tape width of the mounted tape;
address registration means for registering information of n items (n is an integer equal to or larger than 2) which are components of an address of a mail article, as address information;
address printing instruction means for instructing address printing;
first tape width address printing means for arranging, in response to the instruction of the address printing, item images representative of information of the n respective items based on the address information as respective lines of a single block, and printing the single block, if the detected tape width is a first tape width;
second tape width address printing means for grouping, in response to the instruction of the address printing, the item images representative of information of the n respective items into m blocks (m is an integer defined as 2≦m≦n) based on the address information, arranging the grouped item images as respective lines of k blocks (k is an integer defined as 1≦k≦m) of the m blocks, and printing the k blocks on a block-by-block basis, if the detected tape width is a second tape width smaller than the first tape width; and
tape cutting means for cutting off a printed portion of the mounted tape as an address label.
